(19) United States
(12) Patent Application Publication
(10) Pub. No.: US 2025/0085475 A1
(43) Pub. Date: Mar. 13, 2025

(54) SYSTEMS AND METHODS FOR IMPROVED DATA TRANSMISSION

(71) Applicant: Meta Platforms Technologies, LLC, Menlo Park, CA (US)

(72) Inventors: Richard Farrell, Seattle, WA (US); Nihar Ranjan Mohanty, Snoqualmie, WA (US)

(21) Appl. No.: 18/463,855

(22) Filed: Sep. 8, 2023

(51) Int. Cl. G02B 6/13; G02B 6/124

(52) U.S. Cl. CPC G02B 6/13; G02B 6/124

(57) ABSTRACT

Systems and methods for manufacturing an optical waveguide may include singulating a waveguide blank from a substrate to a substantially final shape; after singulating the waveguide blank, apply an optical grating over the waveguide blank; and after singulating the waveguide blank, apply at least one coating to the waveguide blank.

### BRIEF DESCRIPTION OF DRAWINGS

The accompanying drawings illustrate a number of example embodiments and are a part of the specification. Together with the following description, these drawings demonstrate and explain various principles of the present disclosure.

FIG. 1 is a flow diagram illustrating a method for manufacturing optical waveguides, according to at least one embodiment of the present disclosure.

FIG. 2 is a flow diagram illustrating a method for manufacturing optical waveguides, according to at least one additional embodiment of the present disclosure.

FIG. 3 illustrates a workpiece at various stages of manufacturing for forming an optical waveguide, according to at least one embodiment of the present disclosure.

FIG. 4 is a cross-sectional side view of an optical waveguide, according to at least one embodiment of the present disclosure.

FIGS. 5A and 5B are exemplary views of example system configurations, according to at least one embodiment of the present disclosure.

FIG. 6 is an exemplary view of a drive scheme for a display, according to at least one embodiment of the present disclosure.

FIG. 7 is an exemplary view of drive scheme illustrations, according to at least one embodiment of the present disclosure.

FIGS. 8A and 8B are exemplary views of drive schemes, according to at least one embodiment of the present disclosure.

FIGS. 9A and 9B are exemplary views of a dynamic backlight duty ration adjustment method, according to at least one embodiment of the present disclosure.

FIG. 10 is a cross-sectional side view of a waveguide, according to at least one embodiment of the present disclosure.

FIG. 11 is a cross-sectional side view of a waveguide, according to at least one additional embodiment of the present disclosure.

FIG. 12A is a cross-sectional side view of a waveguide, according to at least one further embodiment of the present disclosure. FIG. 12B is a plot illustrating how efficiency can change across the waveguide of FIG. 12A from a first location a to a second location b.

FIG. 13 is a cross-sectional side view of a waveguide, according to at least one other embodiment of the present disclosure.

FIG. 14 is a cross-sectional side view of a waveguide, according to at least one additional embodiment of the present disclosure.

FIG. 15 is a plot illustrating the efficiency of a waveguide with different levels of homeotropic anchoring energy of a polarization volume hologram region at various wavelengths, according to at least one embodiment of the present disclosure.

FIG. 16 is a side view of a waveguide with a mask for providing variability in a combiner of the waveguide, according to at least one embodiment of the present disclosure.

FIG. 17 is a side view of a waveguide with a combiner of the waveguide having different amounts of a surfactant for providing variability in the combiner, according to at least one embodiment of the present disclosure.

FIG. 18 shows a block diagram of a circuit according to some examples.

FIG. 19 shows a further block diagram of a circuit according to some examples.

FIGS. 20A and 20B illustrate an example circuit response to a brownout event, according to some examples

FIG. 21 shows an example battery response to a brownout event according to some examples.

FIG. 22 shows an example circuit response to a brownout event according to some examples.

FIG. 23 shows a further example circuit response to a brownout event according to some examples.

FIG. 24 shows a table illustrating the performance of a digital supercapacitor circuit, according to some examples.

FIG. 25 illustrates a method including reducing a voltage drop in a supply voltage, according to some examples.

FIG. 26 illustrates a further method including charging a capacitor using a boost voltage and reducing the discharge signal voltage, according to some examples.

FIG. 27 illustrates a further method including at least partially discharging a capacitor to reduce a supply voltage drop where the capacitor is charged to a higher voltage than the supply voltage, according to some examples.

FIG. 28 is an illustration of exemplary augmented-reality glasses that may be used in connection with embodiments of this disclosure.

FIG. 29 is an illustration of an exemplary virtual-reality headset that may be used in connection with embodiments of this disclosure.

Throughout the drawings, identical reference characters and descriptions indicate similar, but not necessarily identical, elements. While the example embodiments described herein are susceptible to various modifications and alternative forms, specific embodiments have been shown by way of example in the appendices and will be described in detail herein. However, the example embodiments described herein are not intended to be limited to the particular forms disclosed. Rather, the present disclosure covers all modifications, equivalents, and alternatives falling within this disclosure.

### DETAILED DESCRIPTION OF EXAMPLE EMBODIMENTS

### Methods for Manufacturing Optical Waveguides

Optical waveguides transmit an image (e.g., from a projector) from an input location to a different location for display to a user. For example, in augmented-reality glasses, a projector located along or near an edge of a waveguide lens projects light into an input grating of the waveguide lens, and the waveguide lens transmits the image to a central portion of the waveguide lens for display to the user. In augmented-reality glasses, the waveguide lens is generally transparent to visible light, such that the user can view the real world through the waveguide lens while also viewing the projected and transmitted image overlaying the view of the real world.

Waveguides are often manufactured using traditional semiconductor fabrication techniques. For example, a wafer substrate may be processed to form multiple waveguides on the wafer substrate. Gratings, coatings, and the like for the multiple waveguides may be defined on a single wafer substrate. Later, the wafer substrate may be singulated (e.g., diced) to separate the multiple waveguides from each other. The waveguides are then assembled into optical lens and/or display packages. Such wafer-based fabrication is typically a low-risk approach due to the maturity of processes in the semiconductor industry. However, the cost can be high, such as due to overshooting the quality needs of optical devices and due to providing manufacturing equipment that is large enough to accommodate the wafers.

The present disclosure is generally directed to methods for manufacturing optical waveguides that can reduce cost and otherwise improve existing techniques. For example, a common eyepiece blank may be provided for forming waveguides of various types and styles. The eyepiece blanks may be processed (e.g., formation of gratings, application of coatings, etc.) after singulation, rather than at a wafer-level.

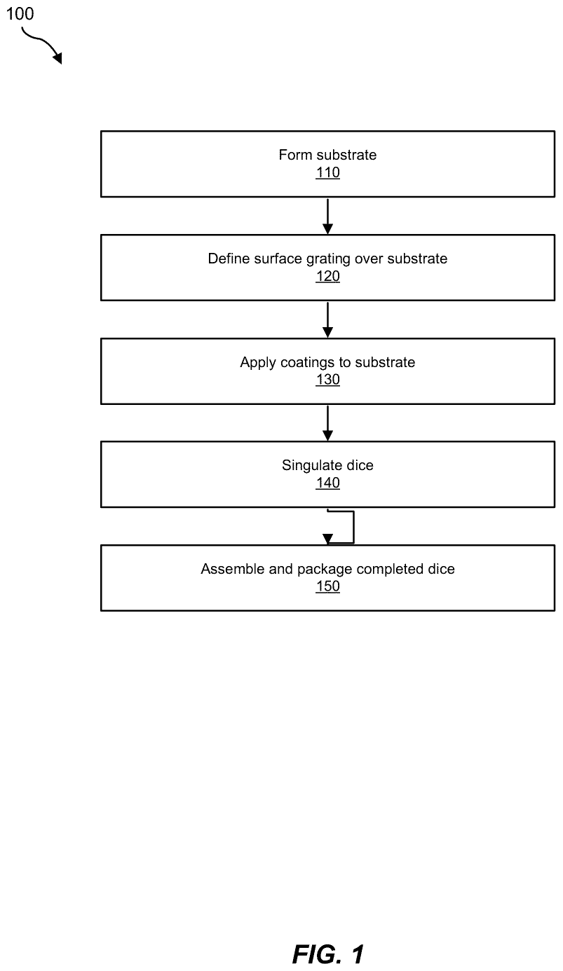

FIG. 1 is a flow diagram illustrating a method 100 for manufacturing optical waveguides, according to at least one embodiment of the present disclosure. At operation 110, a substrate (e.g., an optical substrate) may be formed. At operation 120, a surface grating may be defined over the substrate. For example, the surface grating may be a surface relief grating (“SRG”), a grated waveguide (“GWG”) grating, a volume Bragg grating (“VBG”), and/or a polarization volume hologram (“PVH”) grating. At operation 130, coatings may be applied to the substrate. For example, the coatings may include protective coatings, optical coatings, and/or adhesive coatings. At operation 140, the waveguides (also referred to as “dice”) may be singulated from the substrate, such as by etching or otherwise cutting the substrate in the shape of the waveguides. At operation 150, the completed dice may be assembled and packaged, such as in an optical lens package and/or a display package. For example, the waveguide may be coupled to a frame, one or more additional lenses, an eye-tracking device, a display projector, etc.

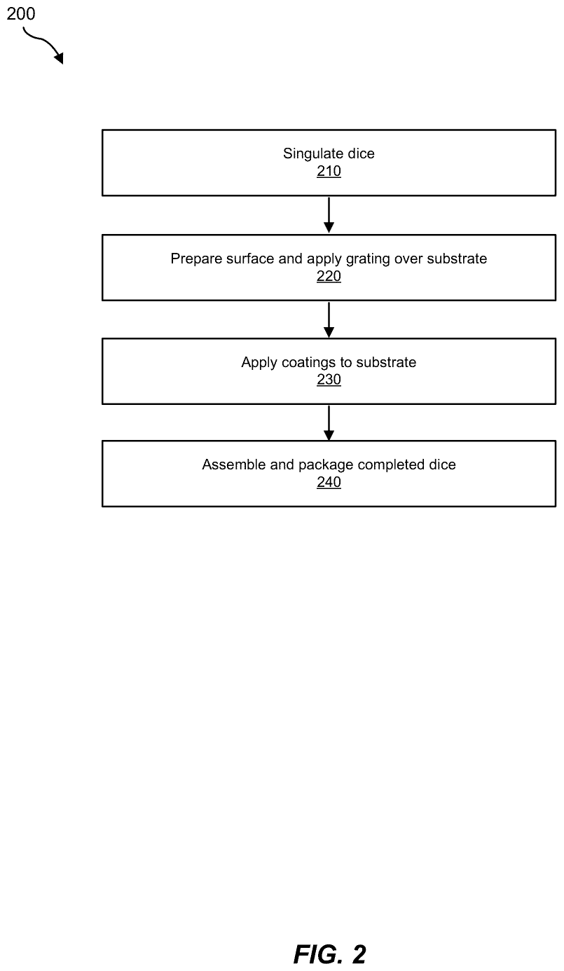

Using the method 100, several of the processes (e.g., operations 120 and 130) may be performed when the substrate (e.g., a wafer) including multiple waveguide blanks is intact. Next, in connection with FIG. 2, a method will be described in which waveguide blanks can be processed after singulation.

FIG. 2 is a flow diagram illustrating a method 200 for manufacturing optical waveguides, according to at least one additional embodiment of the present disclosure. At operation 210, dice (e.g., waveguide blanks) may be singulated from a substrate. These waveguide blanks may have a substantially final (e.g., final or near-final) outer shape (e.g., in the shape of an eyeglass lens). At operation 220, the surface of the dice may be prepared (e.g., cleaned) and a grating may be applied over a substrate of the dice. At operation 230, coatings may be applied to the substrate. At operation 240, the completed dice may be assembled and completed, such as into a lens package and/or a display package.

In some examples, the term “substantially” in reference to a given parameter, property, or condition, may refer to a degree that one skilled in the art would understand that the given parameter, property, or condition is met with a small degree of variance, such as within acceptable manufacturing tolerances. For example, a parameter that is substantially met may be at least about 90% met, at least about 95% met, at least about 99% met, or fully met.

Operations 220 and 230 may be performed on individual dice/waveguide blanks and/or on a batch of dice/waveguide blanks.

By singulating the dice from a substrate at operation 210 prior to performing the operations 220 and 230, costs may be reduced compared to wafer-level processing. In addition, examples of the present disclosure may include forming many different types of gratings, such as SRG, GWG, VBG, and/or PVH gratings.

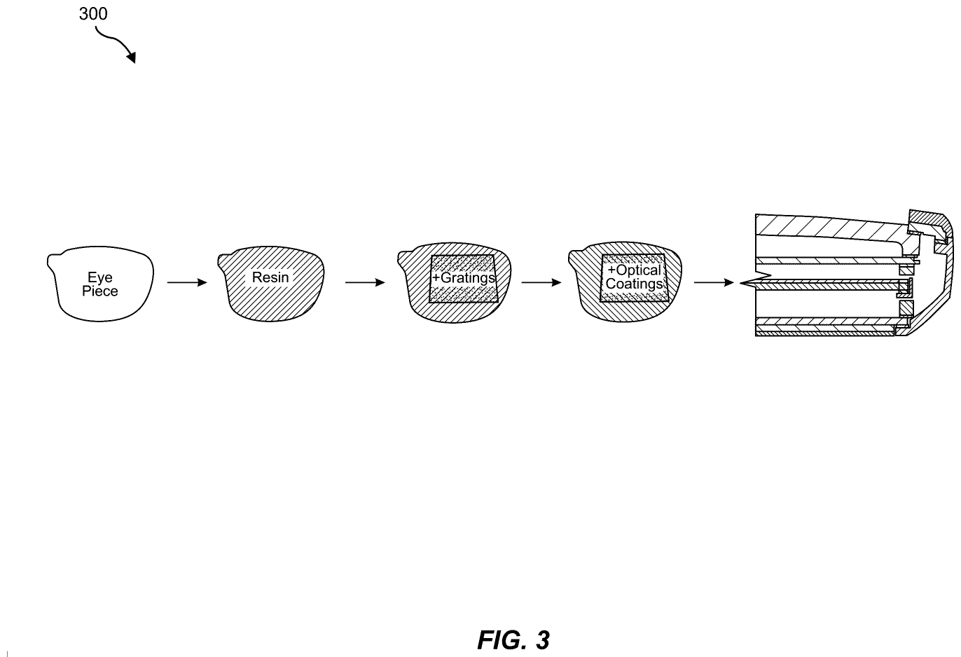

FIG. 3 illustrates a workpiece 300 at various stages of manufacturing for forming an optical waveguide, according to at least one embodiment of the present disclosure. For example, an eye piece may be formed by singulating an optical substrate into a final or near-final shape (e.g., in the shape of an eyeglass lens). The singulated eye piece may be processed, either individually or in a batch, to apply a resin or other surface treatment to a surface of the eye piece. Gratings may then be applied to the eye piece, such as input and/or output gratings (e.g., SRG, GWG, VBG, and/or PVH gratings). Optical coatings may then be applied over the substrate and gratings, such as for protection, optical performance, etc. The completed eye piece may then be assembled into a package, such as a lens package, a display package, etc.

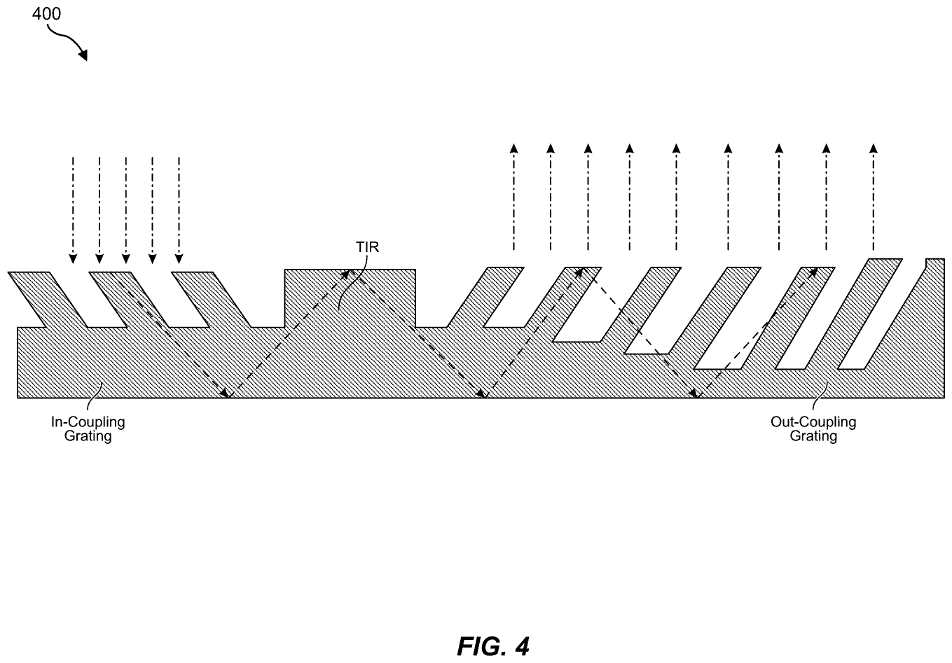

FIG. 4 is a cross-sectional side view of an optical waveguide 400, according to at least one embodiment of the present disclosure. The optical waveguide 400 may be formed by any of the methods discussed above. The optical waveguide 400 may include an in-coupling grating, which may be an input for an image, such as from a projector or other image source. The image may be transmitted through a total internal reflection (“TIR”) portion of the waveguide toward an out-coupling grating. The out-coupling grating may provide an output of the image, such as to display the image to a user. The optical waveguide 400 may be an example of a waveguide with an SRG grating.

### Example Embodiments

Example 1: A method for manufacturing an optical waveguide, the method including (a) singulating a waveguide blank from a substrate to a substantially final shape, (b) after singulating the waveguide blank, apply an optical grating over the waveguide blank, (c) after singulating the waveguide blank, apply at least one coating to the waveguide blank.

### Dynamic Backlight Driving for Different Display Frame Rates

Augmented reality and/or virtual reality (AR/VR) devices may include a display configured to provide virtual or augmented reality elements. In augmented reality (AR), the AR image elements may be combined with light from an external environment. To display AR/VR images, a liquid crystal (LC) display may be illuminated by a backlight unit (BLU). A BLU may include, for example, an arrangement of light-emitting diodes (LEDs).

For near-eye applications, a display (e.g., a liquid crystal display, LCD) may have a high ppi (pixels per inch) to provide high resolution images. The display may be associated with a backlight (such as an LED-based BLU), and the backlight illumination may use light pulses rather than continuous illumination of the display. Light pulses may reduce or eliminate perceived motion blur for displayed moving images, relative to continuous illumination.

High display refresh rates provide sharper image quality, particularly for video signals including fast-moving image components. However, there may be challenges for achieving high display refresh rates in an AR/VR display, as discussed in more detail below. The drive signal provided to a display assembly (e.g., including a display panel and a BLU) may be divided into frames. Each frame extends over a frame time, and the refresh rate (or frame rate) may be the reciprocal of the frame time. An example frame may include an illumination pulse from a backlight, a scan time (during which the display is addressed to display the next image), and a blank time. The blank time may extend over the remainder of the frame time. In some examples, the display is not illuminated or addressed during the blank time.

After addressing, various pixels may be switched into another state (e.g., light to dark or dark to light). The switching process may not be instantaneous, particularly for an LCD, and the time to achieve a stable switched state may be termed the settling time. The following illumination pulse may follow the settling time to prevent image artifacts such as ghost images. In some examples, the blank time may be increased to allow the LCD to settle before the next illumination pulse. The blank time may follow the scan time and may start when the scan time ends and continue to the end of the frame time. The blank time may be sufficiently long so as to allow the LC to settle before the backlight illuminates the display again (e.g., in the following frame).

Conventionally, the backlight duty ratio used for illuminating the display may remain the same for all drive frequencies (e.g., display refresh rates) to achieve a constant average display brightness. Using this approach, the typical LC response time (and consequent settling time) may present challenges for high refresh rates. For example, a typical LC settling time may be around 4 ms. If the blank time is less than the settling time, then visible artefacts may be discernable by a viewer as the liquid crystal alignment may not have achieved a stable state by the time of the next backlight illumination pulse. This may reduce the contrast ratio of the display, lead to ghost images, and may introduce flow effects or other switching related artifacts into the displayed image.

As noted above, a high display refresh rate allows a sharper image for fast moving videos. For example, a refresh rate of 140 Hz may provide an appreciably sharper image than that using a refresh rate of 60 Hz. However, at high refresh rates, there may be insufficient time for the LC to fully settle between frames, and the blank time may be reduced to less than the LC settling time. This is discussed in more detail below. Scan times may be longer for higher resolution displays leading to a shorter blank time. Shorter frame times (higher refresh rates) may also lead to a shorter blank time.

Dynamic backlight control of the backlight duty ratio allows a longer blank time to be obtained, for example, to approximately equal to or greater than the settling time. In this context, the settling time may be the time for the alignment of a liquid crystal to obtain a stable final state after addressing (e.g., switching of one or more pixels). The settling time may be approximately equal to or otherwise based on the LC switching time.

In some examples, the BLU duty ratio may be reduced to obtain a longer blank time compared to that available for an unchanged duty ratio. Reducing the duty ratio shortens the illumination pulse length provided by the BLU. In some examples, the scan time may follow the illumination pulse and shortening the illumination pulse allows the scan time to start and finish earlier within the frame time (compared with use of an unchanged illumination pulse). The scan time then may be increased, for example, by a time corresponding to the decrease in the length of the illumination pulse.

In some examples, the duty ratio may be adjusted based on the frame rate. For example, the duty ratio may be reduced when the frame rate is increased to provide a longer blank time to allow the LC to settle. In some examples, the backlight current may also be adjusted so that the average display brightness remains the same. For example, the backlight current may be increased if the duty ratio is reduced or vice versa.

The higher peak drive currents associated with shorter duty ratios may be considered undesirable in view of the shortening of the LED lifetimes that may occur. However, as discussed herein, the advantages of increasing the scan time may outweigh any perceived negative consequences of higher peak drive currents. However, if the frame rate is decreased so that additional blank time is no longer necessary, the duty ratio may be increased. In some examples, a controller may determine a frame time (or frame rate) based on the image content, and then determine a duty ratio based on the frame time. The duty ratio may be selected as sufficiently small to allow a sufficient blank time. A sufficient blank time may be at least 0.75 of the settling time, such as at least 0.8, such as at least 0.9, such as at least 0.95 of the settling time. A sufficient blank time may be, for example, approximately equal to or greater than the settling time. In some examples, the duty ratio may be reduced to a minimum available duty ratio, such as 5%.

In some examples, the blank time may be increased by at least 0.1 ms, such as by at least 0.2 ms, and in some examples by at least 0.4 ms. In some examples, the blank time may be increased by 0.42 ms, for example, the blank time may be increased from 3.5 ms to 3.92 ms, close to a typical LC settling time of 4 ms.

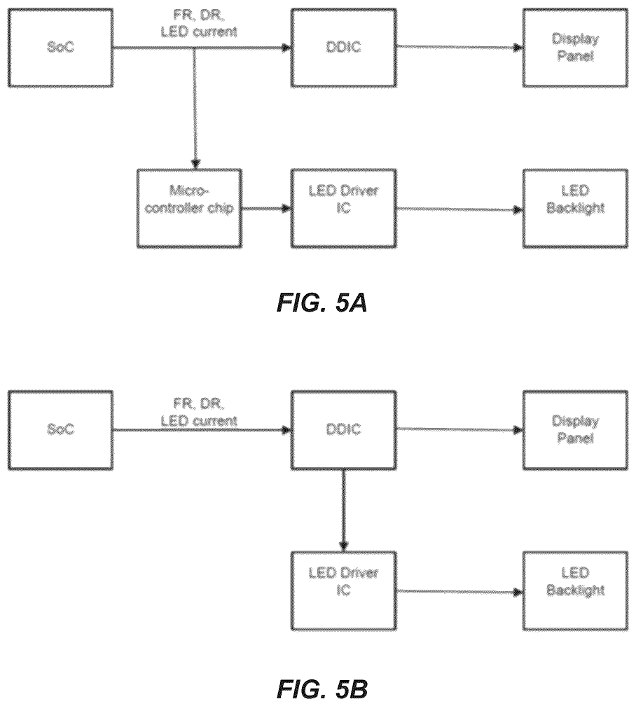

FIGS. 5A and 5B show example system configurations. An AR/VR device may include a display assembly including a display panel and a backlight unit (BLU). FIG. 5A shows an SoC (system on a chip) configured to help drive the display. The frame rate (FR), duty ratio (DR) and LED current may be determined (e.g., by a controller including or in communication with the SoC) and output to the DDIC (display driver integrated circuit). The DDIC may drive the display panel using a video signal at the desired frame rate. In some examples, the frame rate may be adjusted based on the motion content of the video signal and/or the estimated rendering time of the video signal. An optional microcontroller may receive at least the duty ratio and the LED current and communicate associated data to the LED driver IC, which then drives the LEDs in the backlight unit (BLU).

FIG. 5B shows a similar system in which the microcontroller chip is omitted and the DDIC passes the duty ratio and LED current to the LED driver IC.

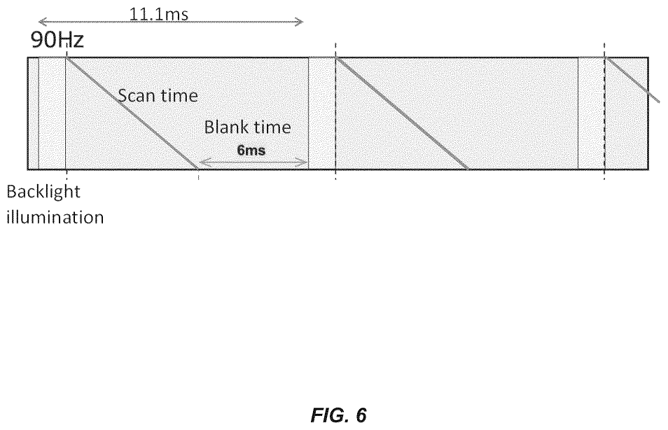

FIG. 6 shows an example drive scheme for a display. For AR/VR applications, the display is a near-eye display and may have a high ppi (pixels per inch) to provide a high-resolution display. The backlight illumination may be pulsed to avoid user-perceptible motion blur in a moving image. The duty ratio may be the fraction of the frame time for which the backlight is illuminated. A duty ratio of 100% may represent continuous illumination and this may lead to undesirable motion blur in a displayed moving image.

In the illustrated drive scheme, the display refresh rate may be 90 Hz and the corresponding frame time may be 1/90 second or 11.1 ms. The figure illustrates two successive frame times. The backlight illumination may be a light pulse at or near the beginning of the frame time, demarcated by two vertical lines. The scan time follows the backlight illumination, and the remainder of the frame time may be a blank time. The blank time may correspond to a time period when the display is not addressed or illuminated. The blank time allows the LC orientation to stabilize before the next backlight illumination pulse at or near the beginning of the next frame time. In the illustrated example, the blank time may be 6 ms. This time may be long enough to allow the LC alignment to stabilize (settle) before the next backlight illumination pulse.

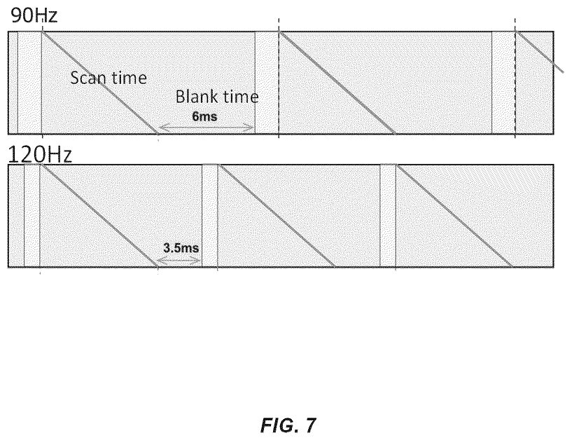

FIG. 7 shows a comparison of the first drive scheme illustrate in FIG. 6 (with a frame rate of 90 Hz) with a second drive scheme having a frame rate of 120 Hz. The second drive scheme has a blank time of 3.5 ms. However, a typical LC settling time may be approximately 4 ms. In the second drive scheme with a higher frame rate, there may not be enough time for the LC to settle during the blank time.

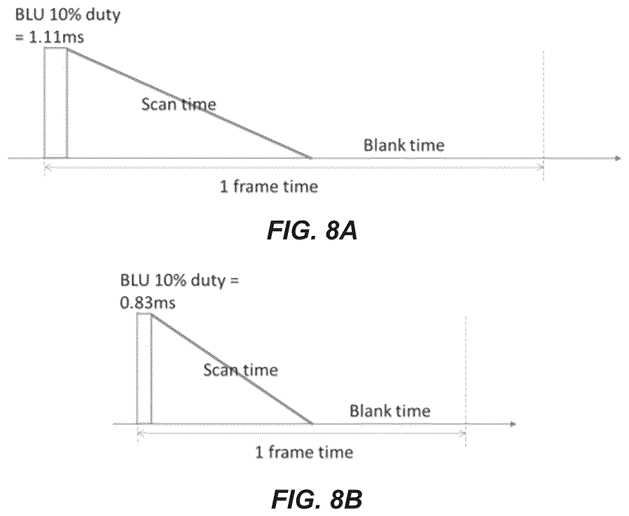

FIGS. 8A and 8B illustrate example drive schemes. The drive scheme of FIG. 8A uses a frame rate of 90 Hz. The backlight unit (BLU) has a duty ratio of 10% and is illuminated for 10% of the frame time. The frame time is 1/90 seconds (11.1 ms), and the BLU is illuminated for 1.11 ms during each frame. The drive scheme of FIG. 8B uses a frame rate of 120 Hz, a frame time of 1/120 seconds (8.3 ms), a BLU duty ratio of 10% and a BLU illumination time of 0.83 ms. However, this drive scheme may not provide s sufficient blank time for the LC to settle before the next backlight illumination pulse.

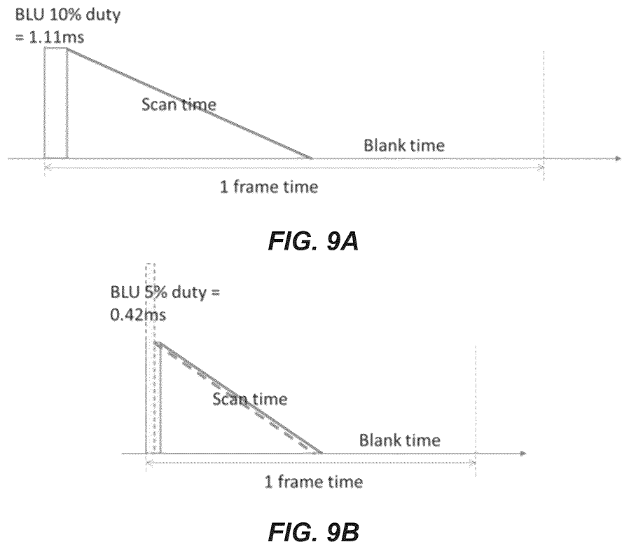

FIGS. 9A and 9B illustrate an example approach to increasing the blank time using a dynamic backlight duty ratio adjustment (and optionally a dynamic current adjustment) when frame rate is changed. The drive scheme of FIG. 9A uses a frame rate of 90 Hz and is similar to that shown in FIG. 8A. The drive scheme of FIG. 9B uses a higher frame rate of 120 Hz. In this example, the duty ratio is reduced, for example, by a factor of 2 to 1/(2*120) ms or 0.42 ms. This backlight illumination pulse is (within rounding) 0.42 ms shorter than backlight illumination pulse of the drive scheme illustrated in FIG. 8B. Hence, the scan time then starts and ends 0.42 ms earlier in the frame time period (compared to the drive scheme of FIG. 8B) due to the shorter BLU illumination pulse. Therefore, the blank time starts 0.42 ms earlier within the frame, providing an additional blank time of 0.42 seconds for LC settling. The upper solid line represents the scan time of the approach shown above in FIG. 8A, and the lower dashed line shows the scan time in this example approach using a shorter BLU pulse.

The duty ratio may be reduced to provide additional time for the LC to settle. For example, if the BLU illumination pulse for each frame is originally X ms, the BLU illumination pulse may be reduced to X/N (where N is a number greater than 1). In some examples, N=2 (e.g., as shown in FIG. 5B), though N is not limited to 2. For example, N may be between 1.25 and 5, for example, N may be between 1.5 and 3. In the example shown in FIGS. 5A and 5B, the duty ratio may be reduced from 10% to 5%, the BLU light pulse may reduce in duration from 8.3 ms to 4.2 ms (a reduction of approximately 0.42 ms), and the blank time may be increased by 0.42 ms, allowing additional time for the LC to settle. For example, the blank time may increase from 3.5 ms to 3.92 ms, which is close to a typical LC settling time of 4 ms.

In some examples, the backlight current may be adjusted by a factor selected so that the average brightness of the backlight remains the same. For example, if the duration of the backlight pulse is reduced by a factor N, the drive current may be increased by a factor N, or by some other factor that helps maintain an approximately constant average BLU brightness. Similarly, if the frame rate is reduced and the duration of the BLU illumination pulse is increased by a factor M, the drive current may be reduced by a factor M, or other factor that that helps maintain an approximately constant average BLU brightness.

In some examples, the low temperature performance of an LC display may be improved by increasing the blank time using approaches described herein. The settling time of an LC may be temperature dependent due to the temperature dependence of the liquid crystal viscosity parameters. In some examples, a device may include a temperature sensor located in, supported by, substantially adjacent to or proximate the display. The display temperature (or other temperature, such as the ambient temperature) may be used in the determination of an appropriate blank time.

In some examples, additional blank time may be obtained by reducing the scan time, for example, by selectively addressing a subset of rows and/or columns (e.g., a subset including a moving image component). If reducing the duty ratio to a minimum available duty ratio is not sufficient to obtain an acceptable blank time, then the scan time may be reduced by any suitable approach to obtain an acceptable blank time.

### Example Methods

A method of operating a display assembly including a display and a backlight includes displaying an image at a first frame rate on the display, illuminating the display with light pulses from the backlight where the light pulses have a first duty ratio, displaying an image at a second frame rate on the display, and illuminating the display with light pulses from the backlight where the light pulses have a second duty ratio. The second frame rate (e.g., expressed in Hz) may be higher than the first frame rate, and the second duty ratio (e.g., expressed as a percentage) may be less than the first duty ratio.

In some examples, a method may include decreasing the duty ratio of a backlight in response to an increase in frame rate of the display. The method may further include increasing the drive current applied to light emissive elements in the backlight to maintain an approximately constant backlight brightness (e.g., constant within 10%, such as within 5%). For example, if the duty ratio is reduced from 10% to 5%, the brightness of the backlight while illuminated may be doubled. This may correspond to a doubling of the drive current supplied to the light emissive elements of the backlight, or other increase in drive current depending on the current-emissivity properties of the light emissive elements.

In some examples, the frame rate for a particular application (or particular time period during use of an application) may be predetermined based on the particular content. For example, if the particular content includes a relatively fast-moving video, the frame rate may be selected to be a higher value (e.g., 90 Hz or greater). If the particular content is does not include video segments and, for example, mostly includes a generally static display, the frame rate may be selected to be a lower value (e.g., less than 90 Hz, such as 60 Hz or less). The duty ratio of the display may then be adjusted based on the selected frame rate. In some examples, the frame rate may be selected based on hardware capabilities. For example, a lower frame rate may be selected for video display if the hardware is not capable of satisfactory image rendering at higher frame rates, for example, for higher resolution images. The duty ratio may be increased for lower frame rates.

Example methods may include computer-implemented methods for operating or fabricating an apparatus, such as an apparatus as described herein. The steps of an example method, such as adhering components together, may be performed by any suitable computer-executable code and/or computing system. In some examples, one or more of the steps of an example method may represent an algorithm whose structure includes and/or may be represented by multiple sub-steps. In some examples, a method for assembling an optical device such as an AR/VR device may include computer control of an apparatus.

In some examples, an apparatus may include at least one physical processor and physical memory including computer-executable instructions that, when executed by the physical processor, cause the physical processor to control an apparatus, for example, using a method such as described herein.

In some examples, a non-transitory computer-readable medium may include one or more computer-executable instructions that, when executed by at least one processor of an apparatus, cause the apparatus to at least partially assemble an optical device, for example, using a method such as described herein.

### Further Examples

Displays may include liquid crystal on silicon (LCoS) displays that may be operated in reflective mode. The display illumination may be located in front of the display and the light reflected after passing through the LC layer. This type of display illumination may be referred to as a backlight even if it is not located behind the display. A backlight may include an illumination source for which the display panel provides spatial and time modulation of intensity and/or color. In some examples, the display may be operated in transmissive mode and light from the backlight may pass through the display panel. A display panel may include an alignment layer, electrodes, and electronic circuitry configured to hold a pixel in a particular state between scan times. A display panel may include color filters associated with pixels and/or sub-pixels. A display panel may include one or more polarizers. An LC layer may be located between substrates (e.g., glass, silicon, and the like), and substrates may support or otherwise include alignment layers. Switching may include electric fields applied perpendicular, parallel, or otherwise directed relative to the substrates.

For a backlight driven using electrical pulses with a particular duty ratio, the blank time (e.g., allowing for LC settling between the end of display addressing (the end of the scan time) and the next illumination pulse) may be increased using a dynamic backlight duty ratio and dynamic drive current. The duty ratio and the drive current may be adjusted based on the frame rate. For example, if the frame rate is increased, the duty ratio may be reduced to provide more time for LC settling by increasing the blank time, and the backlight current may be increased accordingly so that the average backlight brightness remains the same.

Improved LCD images may be obtained for faster refresh rates by increasing the backlight brightness and reducing the duty ratio of the illumination pulse. This increases the available blank time and allows the liquid crystal to settle before the next frame. Pulsed illumination of a display backlight helps reduced motion blur, but pulsed illumination before an LCD has time to settle may result in ghost images. This may not be an issue for slower refresh rates (e.g., 70 Hz) but may become a problem at faster refresh rates (e.g., 120 Hz). Different refresh rates may then be readily used for different applications. For example, a faster refresh rate may be selected if rendering time is not an issue, for example, for a particular application. If displayed images for a particular application are relatively simple (e.g., lower resolution) then the frame rate may be increased.

An apparatus may include a display panel (e.g., a liquid crystal display), a backlight, and a controller, wherein the controller is configured to display an image on the display panel using a frame rate, illuminate the backlight to provide backlight illumination, adjust the frame rate based on image content data, and adjust a duty ratio of the back light illumination based on the frame rate. The image content data may include resolution, render time, image complexity, and/or a parameter related to the motion of image components within the image.

In some examples, an apparatus may include a display panel (e.g., a liquid crystal display), a backlight, and a controller, wherein the controller is configured to display an image on the display panel using a frame rate, illuminate the backlight to provide backlight illumination, adjust the frame rate based on image content data, and adjust a duty ratio of the back light illumination based on the frame rate. The image content data may include resolution, render time, image complexity, and/or a parameter related to the motion of image components within the image. Example apparatus may be included in head-mounted devices such as augmented reality and/or virtual reality devices. Examples may also include other devices, methods, systems, and computer-readable media. In some examples, an apparatus includes a display panel, a backlight, and a controller, wherein the controller is configured to display an image on the display panel using a frame rate, illuminate the backlight to provide backlight illumination, adjust the frame rate based on image content data, and adjust a duty ratio of the back light illumination based on the frame rate.

### Optical Waveguide

To achieve spatial brightness uniformity in polarization volume hologram (PVH) waveguide displays, spatially variant thickness is often employed. The controlled thickness of the PVH may vary diffraction efficiency, but controlling the thickness may use a time-consuming and expensive inkjet printing process or other similar process. The geometric step from the inkjet printing process may also cause undesired optical artifacts that degrade optical performance of the waveguide display.

The present disclosure provides detailed descriptions of optical waveguides that may exhibit good brightness and color uniformity. As will be explained in greater detail below, embodiments of the present disclosure may include a liquid crystal polarization hologram (LCPH) coating that can be used as a combiner in the waveguide. The LCPH coating may be formed to have a uniform thickness, but spatially variable efficiency to result in good optical uniformity for the waveguide. Boundary conditions may be controlled to have a different liquid crystal (LC) director profile to control diffraction efficiency and polarization state simultaneously. The disclosed method has potential to be more efficient to fabricate and to reduce optical artifacts that may otherwise be caused by finite step size from conventional inkjet printing methods.

Features from any of the embodiments described herein may be used in combination with one another in accordance with the general principles described herein. These and other embodiments, features, and advantages will be more fully understood upon reading the following detailed description in conjunction with the accompanying drawings and claims.

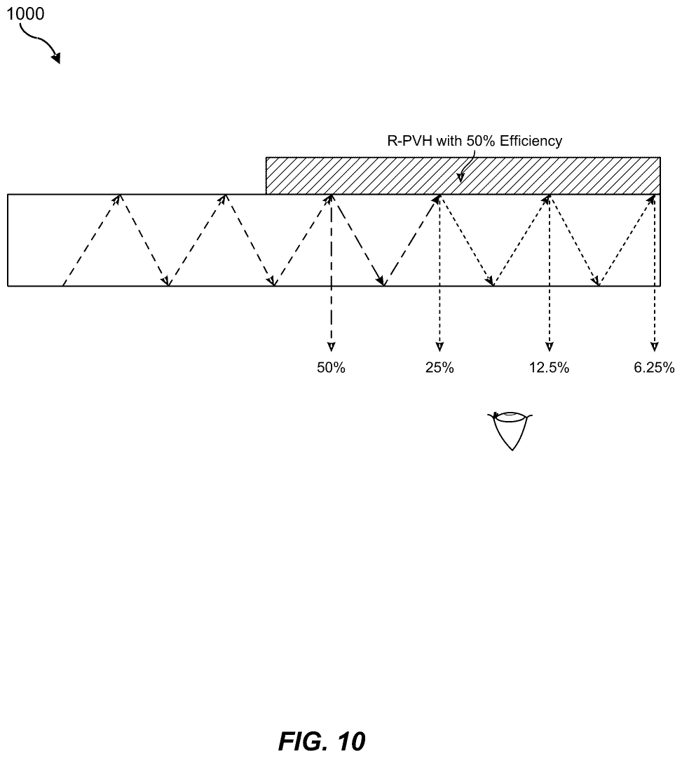

FIG. 10 is a cross-sectional side view of a waveguide 1000 that includes an output region with a reflective-type PVH (R-PVH) grating having 50% efficiency, according to at least one embodiment of the present disclosure. As illustrated in FIG. 10, as light proceeds along the R-PVH grating, the light output becomes less and less bright, such as by 50% each reflection through the R-PVH grating. Accordingly, the brightness of light passing through the R-PVH grating diminishes geometrically, with the brightest light toward the beginning of the R-PVH grating and the dimmest light toward the end of the R-PVH grating.

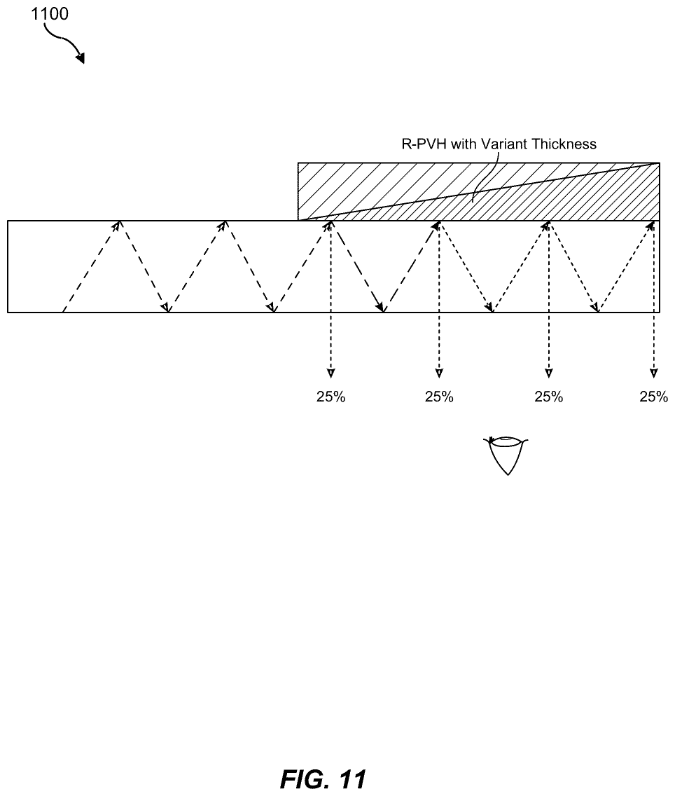

FIG. 11 is a cross-sectional side view of a waveguide 1100, according to at least one additional embodiment of the present disclosure. The waveguide 1100 may include an R-PVH grating that has a variable thickness to account for the loss of efficiency described above with reference to FIG. 10. For example, an initial thickness (e.g., illustrated on a left of the R-PVH grating in FIG. 11) may be less than an end thickness (e.g., illustrated on a right of the R-PVH grating in FIG. 11). This arrangement may enable the reflection of a relatively smaller amount of light toward the beginning of the R-PVH grating and a relatively larger amount of the remaining light toward the end of the R-PVH grating, thus balancing the loss of light and resulting in a generally uniform transmission of light across a geometric area of the R-PVH grating.

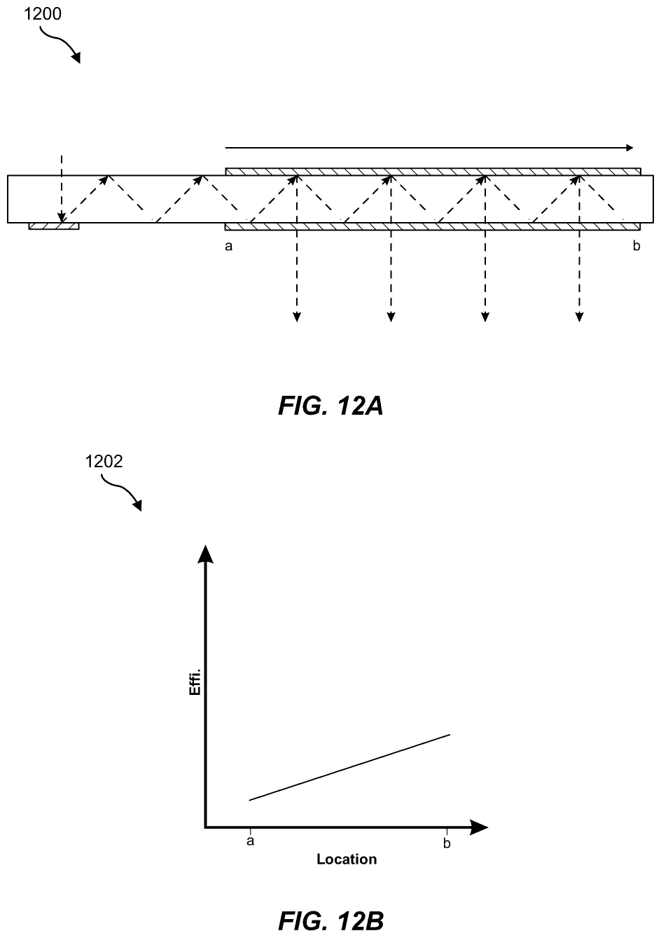

FIG. 12A is a cross-sectional side view of a waveguide 1200, according to at least one further embodiment of the present disclosure. FIG. 12B is a plot 1202 illustrating how efficiency can change across the waveguide of FIG. 12A from a first location a to a second location b. The waveguide 1200 may include an output grating that has a variable thickness from point a (e.g., the point where light enters the output grating) to point b (e.g., the point farthest from point a). As the thickness of the grating changes from point a to point b, the light transmission efficiency may increase (see the plot 1202 of FIG. 12B), allowing a greater portion of remaining light to be output through the grating as the light proceeds along and through the grating from point a to point b. The thickness and efficiency variability may be tailored to result in a substantially uniform brightness profile across the grating.

In some examples, the term “substantially” in reference to a given parameter, property, or condition, may refer to a degree that one skilled in the art would understand that the given parameter, property, or condition is met with a small degree of variance, such as within acceptable manufacturing tolerances. For example, a parameter that is substantially met may be at least about 90% met, at least about 95% met, at least about 99% met, or fully met.

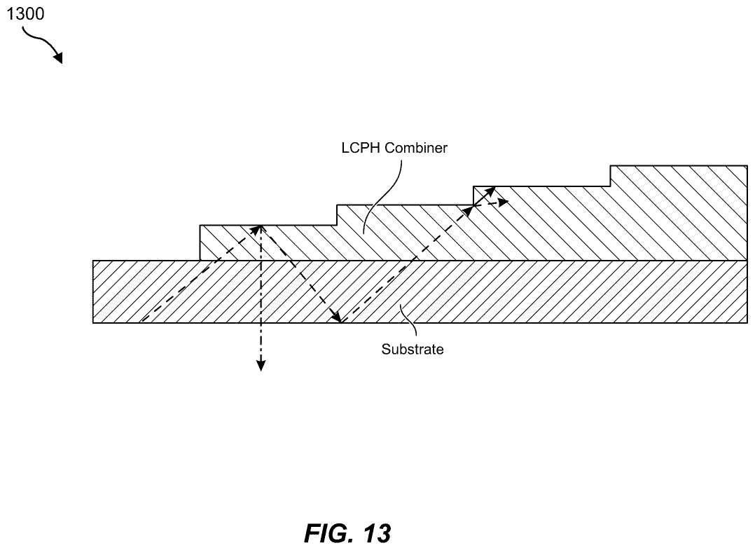

FIG. 13 is a cross-sectional side view of a waveguide 1300, according to at least one other embodiment of the present disclosure. The waveguide 1300 may include a variable-thickness LCPH combiner coating. The LCPH coating may have been formed to have a variable thickness in a stepped arrangement. For example, the LCPH coating may have been formed by an inkjet printing process or other layer addition process. Such processes may result in the stepped arrangement, as illustrated in FIG. 13. As light passes through the substrate and reaches the combiner, the light may initially reflect from/refract through a thin portion of the LCPH coating. As portions of the light continue to progress along and through the LCPH coating, the light may reflect from/refract through progressively thicker portions of the LCPH coating. As shown in FIG. 13, at locations where the LCPH coating steps from one thickness to another thickness, optical artifacts may be introduced. The process (e.g., inkjet printing process) of forming the variable-thickness LCPH coating may also be time-consuming and expensive.

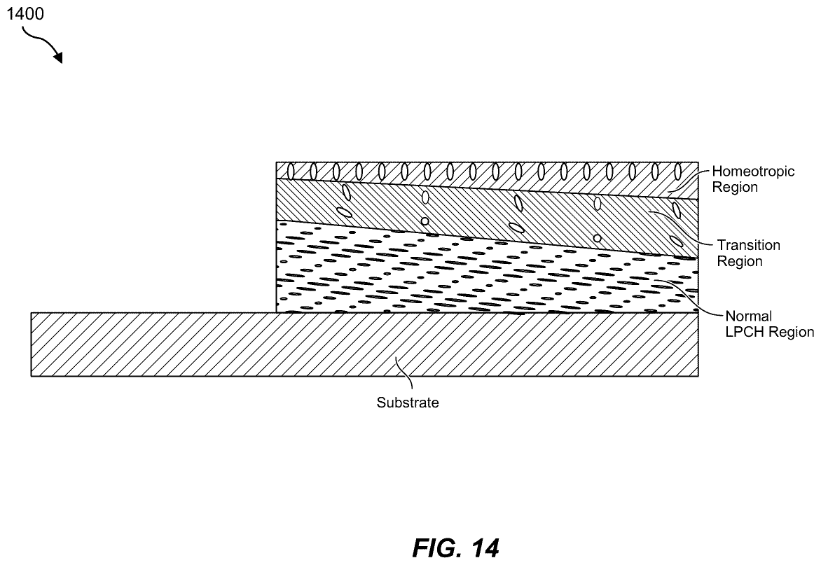

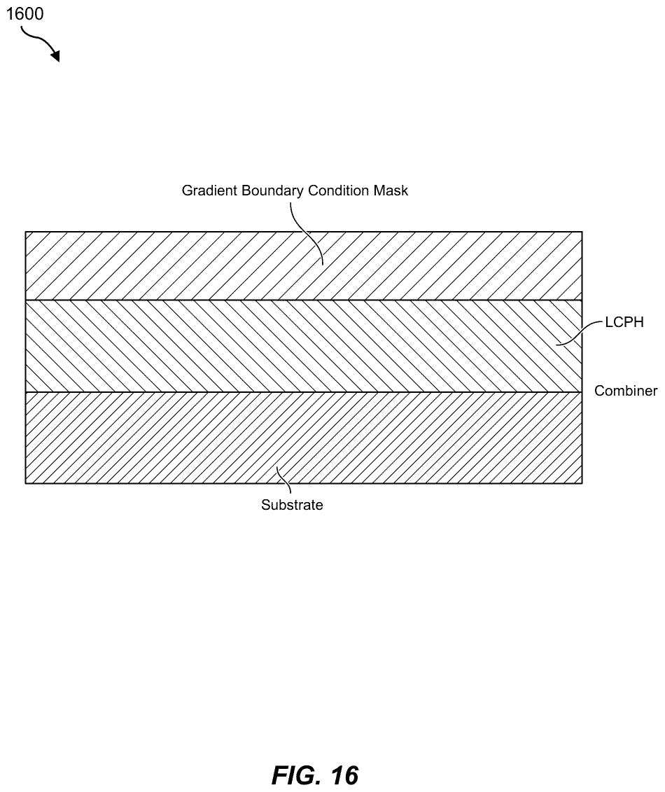

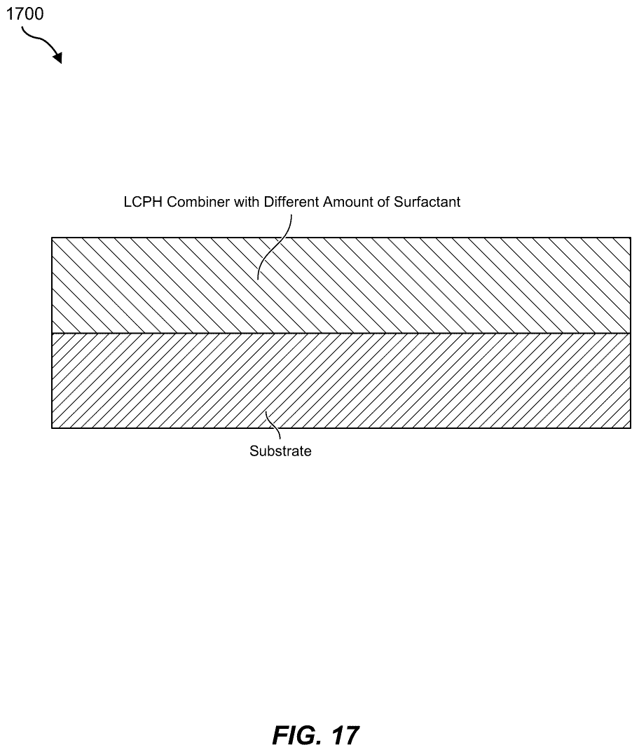

FIG. 14 is a cross-sectional side view of a waveguide 1400, according to at least one additional embodiment of the present disclosure. An LCPH coating of substantially uniform thickness may include a geometrically variable level of homeotropic anchoring, which may result in a corresponding variable optical efficiency across the coating. For example, from left-to-right in the view of FIG. 14, the LCPH coating include a homeotropic region and transition region of increasing thickness, and a normal LCPH region of decreasing thickness. As the thickness of the normal LCPH region decreases, the reflection efficiency may decrease as well. Thus, a spatially variable optical efficiency may be achieved without changing the total film thickness of the LCPH coating. Potential fabrication methods that may result in the variable homeotropic anchoring are illustrated in FIGS. 16 and 17 and are explained below.

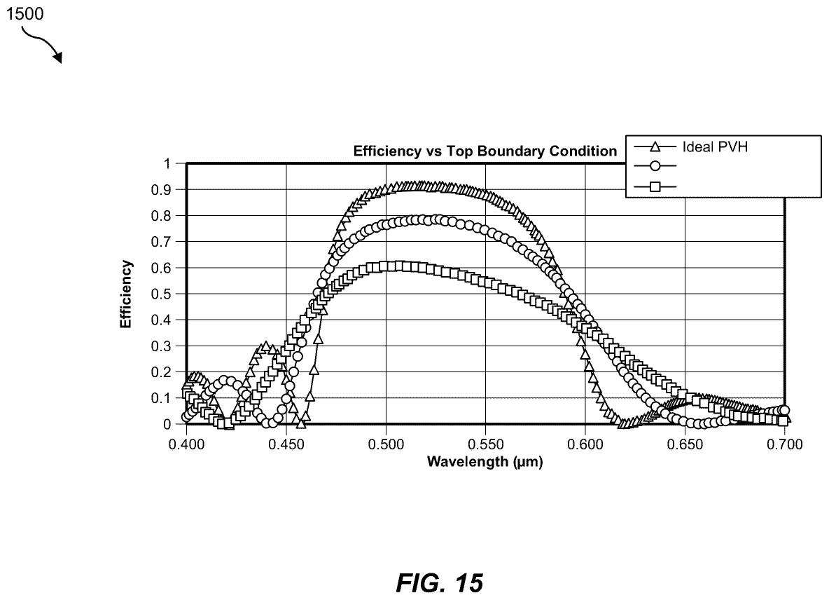

FIG. 15 is a plot 600 illustrating the efficiency of a waveguide with different levels of homeotropic anchoring energy of a PVH region at various wavelengths, according to at least one embodiment of the present disclosure. As shown in the plot 1500, the level of homeotropic anchoring of a LCPH coating may have an effect on an optical efficiency. For example, for a large portion of the visible light spectrum, a strong homeotropic boundary condition may result in a relatively low optical efficiency, a weak homeotropic boundary condition may result in a moderate optical efficiency, and an ideal PVH boundary condition may result in a relatively high optical efficiency.

Thus, the level of homeotropic anchoring of the LCPH coating may be tailored to result in a level of desired reflectance, such as to correspond to and accommodate for a general loss of light as the light progresses through a waveguide including the LCPH coating. In this manner, the LCPH coating may be configured to result in a substantially uniform brightness across the geometry of an output of the waveguide.

FIG. 16 is a side view of a waveguide 1600 with a mask for providing variability in a combiner of the waveguide, according to at least one embodiment of the present disclosure. The waveguide 1600 may be a workpiece in a fabrication process, such as to tune an output of the waveguide to result in a substantially uniform brightness. This tuning may be accomplished by inducing a variability in the homeotropic anchoring, as discussed above with reference to FIGS. 14 and 15.

For example, as illustrated in FIG. 16, the mask may have a gradient boundary condition, such as transmissivity, conductance, thickness, etc. By processing (e.g., by heat-treating or applying radiation) the LCPH combiner through the mask, the level of homeotropic anchoring in the LCPH combiner may correspond to the gradient in the mask. After this processing and curing of the LPCH combiner, the mask may be removed.

FIG. 17 is a side view of a waveguide 1700 with a combiner of the waveguide having different amounts of a surfactant for providing variability in the combiner, according to at least one embodiment of the present disclosure. As illustrated in FIG. 16, the LCPH combiner may be doped with a variable amount of a surfactant. In an air-liquid crystal interface, a liquid crystal molecule may prefer to tilt up as a homeotropic state. Adding more of a suitable surfactant may prevent the tilting up of the liquid crystal. Thus, the amount of surfactant can be used to control a level (e.g., to provide a varying level) of homeotropic anchoring in the LCPH combiner.

Different top boundary conditions may be used to tailor the waveguides in different ways. For example, a spatially variant homotropic boundary condition or a spatially variant planar boundary condition may be utilized to control spatially variant efficiency and/or to spatially control a polarization state. In addition, providing a layer having a variable pitch may be used to form a multi-color combiner.

Accordingly, the present disclosure includes methods and structures for improving a uniformity of output brightness in a waveguide. Such concepts may be used to reduce or eliminate certain types of optical artifacts, such as those induced by coatings with stepped thickness. In addition, manufacturing complexity and cost may be reduced compared to other methods. The concepts of the present disclosure may be employed for a variety of LCPH or other diffractive elements, including those for use with dual wavelengths and those that can exhibit self-polarization compensation. Embodiments of the present disclosure may also be used to fabricate a passive liquid crystal gradient index (LC GRIN) lens. In some examples, concepts of the present disclosure may be suitable for switchable active optical devices.

In addition, embodiments of the present disclosure are not limited to use in optics. For example, concepts disclosed herein may be employed to control surface wettability for micro-fluidics applications, including biologic sensor applications.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered example in nature since many other architectures can be implemented to achieve the same functionality.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

The preceding description has been provided to enable others skilled in the art to best utilize various aspects of the example embodiments disclosed herein. This example description is not intended to be exhaustive or to be limited to any precise form disclosed. Many modifications and variations are possible without departing from the spirit and scope of the instant disclosure. The embodiments disclosed herein should be considered in all respects illustrative and not restrictive. Reference should be made to the appended claims and their equivalents in determining the scope of the instant disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

### Example Embodiments

Example 1: An optical waveguide including an optical substrate and a liquid-crystal polarization hologram coating over the optical substrate, the coating having a substantially uniform film thickness and including (a) a homeotropic region having a variable thickness, (b) a transition region having a variable thickness, and (c) a normal liquid crystal polarization hologram region having a variable thickness.

### Digital Supercapacitor

The present disclosure is directed to apparatus and methods relating to AR/VR devices, which may include at least one of an augmented reality (AR) and/or a virtual reality (VR) device. The AR/VR device may include a display configured to provide virtual or augmented reality elements to the user at a location termed the eyebox. In AR, the AR image elements may be combined with light from an external environment.

An AR/VR HMD (head-mounted device) may have peak power issues. For example, temporary increases in device power consumption may lead to voltage drops and dimming of the display. Power consumption peaks may be caused by subsystems, such as circuits associated with depth measurement, the display, audio, DDR (e.g., a double data rate memory), the GPU (graphics processing unit), and/or other subsystems. The peak power may cause brown-out issues that may shorten the battery usage time and may turn off or compromise the system undesirably.

Examples include lower cost and more power efficient configurations that may reduce or eliminate device performance problems under peak power consumption. Examples include improved AR/VR devices that may have one or more of improved supply voltage stability, improved performance during temporary power consumption surges and improved performance stability.

An example approach to problems caused by power consumption fluctuations is to add additional capacitance between the power connections (e.g., between the supply voltage line and ground). However, capacitors with increased charge storage capabilities are typically physically larger and may require significant additional space in the design form factor. The additional weight and volume may be undesirable. The device cost may also be significantly increased.

In some examples, problems associated with a peak power draw may be reduced or eliminated using active control over a capacitor. In some examples, the charge storage capability may be enhanced by increasing the voltage across the capacitor. The voltage used to charge the capacitor may be actively (e.g., digitally) controlled. The higher voltage applied across the capacitor enables a smaller physical capacitor to be used for a given charge storage. The capacitor may be switched in or out of the device circuit depending upon need for additional power to support power rails and avoids browning out of the supply.

Examples include digital control of a voltage applied across a capacitor to reduce or eliminate peak power problems. Digital control allows effective adjustment of the capacitor voltage (the voltage used to charge the storage capacitor). At least one voltage boost circuit and at least one voltage reduction circuit may be controlled by microcontroller or other controller, which may also be used to detect a voltage drop in the supply voltage having a magnitude greater than a predetermined threshold. Examples of this approach may be used to reduce any power supply browning out issues.

In some examples, an AR/VR device may include a voltage boost circuit to increase the voltage that can be applied to the capacitor. The increased voltage increases the charge that can be stored in the capacitor and allows a physically smaller capacitor to be used in the device circuit to store a particular charge. The stored charge in the capacitor may be used to avoid brown-outs during time periods of high power consumption, such as transient moments of high power consumption.

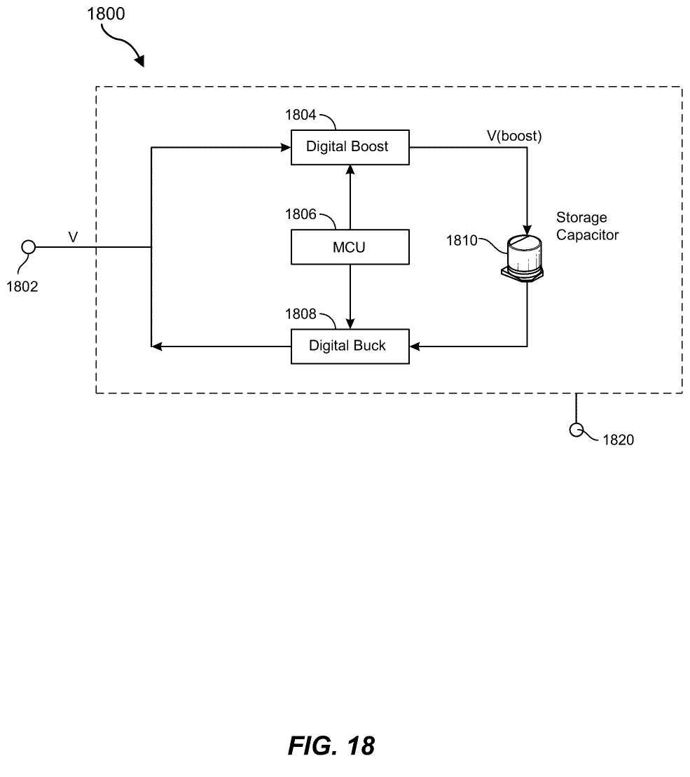

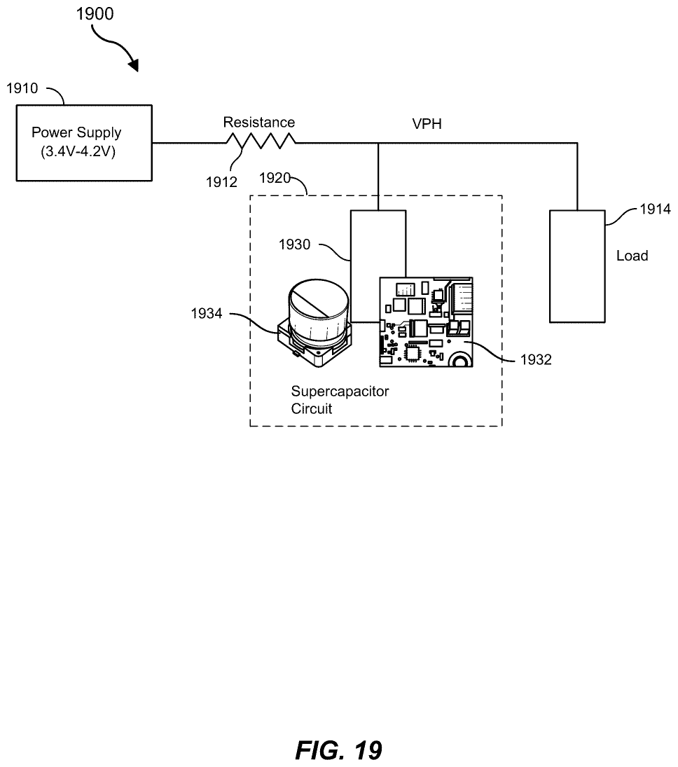

FIG. 18 shows a block diagram of an example circuit 1800. The circuit 1800 includes a digital boost circuit 1804, a microcontroller 1806 (sometimes termed a microcontroller unit, MCU), a digital buck circuit 1808 (sometimes termed a voltage reduction circuit) and a capacitor 1810. The circuit 1800 has a connection 1802 to the power supply line to the load (such as a circuit associated with an AR/VR device) and a ground connection 1820. This is discussed further below in relation to FIG. 19. In some examples, the area of the circuit board may be approximately equal to or less than 400 square mm (e.g., 2 cm×2 cm). In some examples, the area of the circuit board may be approximately equal to or less than 200 square mm (e.g., 1 cm×2 cm). A capacitor may have a height above the board of less than 10 mm, such as approximately equal to or less than 8 mm, such as approximately equal to or less than 4 mm, etc. In some examples, the height of an aluminum capacitor above the circuit board may be less than 8 mm. In some examples, the height of a tantalum capacitor above the circuit board may be less than 4 mm. The physical capacitance of the capacitor may be between 20 microfarads and 500 microfarads.

In some examples, a device may include a supercapacitor circuit in which the available energy storage (e.g., electrostatic energy storage) of the capacitor may be increased by a factor of at least 10, such as at least 100, such as at least 200, and in some examples at least 250. In some examples, a boost factor of approximately 10 may be used to obtain an energy enhancement factor of approximately 100. In some examples, the supply voltage may be between 2.5 V and 5 V. The boosted voltage may be between 6 V and 60 V, such as between 10 V and 50 V. In some examples, the quiescent current of the supercapacitor circuit may be less than 10 mA, such as less than 5 mA, and in some examples less than 3 mA. The power consumption of the supercapacitor circuit may be approximately equal to or less than 10 mW. An example boost circuit was fabricated using a 220 microfarad capacitor with a 16 V rating and a 6×6 mm footprint on the circuit board, but other physical sizes or other values of capacitance and/or voltage rating may be used. In some examples, the operation of the boost circuit and the voltage reduction circuit may be under digital control, for example, using a microcontroller.

In some examples, the effective energy storage provided by the capacitor when charged at the boost voltage may be increased by an energy enhancement factor (which may also be termed as an enhancement factor for conciseness) using the circuit 100, which may be termed a supercapacitor circuit. The enhancement factor may be approximately or at least 10, such as approximately or at least 50, such as approximately or at least 100, and in some examples the enhancement factor may be approximately or at least 200. The current and voltage smoothing effects of the capacitor 1810 may be increased by the enhancement factor. The capacitor 1810, which may be termed a storage capacitor in this context, may have a physical capacitance provided by the capacitor properties, for example, the area of the electrodes, electrode separation, and permittivity of a dielectric layer between the electrodes. In the supercapacitor circuit, the capacitor may provide similar voltage and current smoothing properties to that of a physically and electrically larger capacitor used without the supercapacitor circuit (e.g., without some or all of the other components of the supercapacitor component). The capacitor may have an effective energy storage when charged at the boost voltage that is equal to the same capacitor charged at the supply voltage multiplied by an energy enhancement factor.

The effective capacitance may be similar to the physical capacitance of a capacitor that provides a similar current and/or voltage stabilization as that provided by the supercapacitor circuit. For example, if the physical capacitance is 100 microfarads and the energy enhancement factor is 200, then the effective capacitance may be 100×200 microfarads or 20 millifarads (20 mF). The energy storage capabilities of the capacitor may be enhanced by a factor of approximately 200, for example, using a boost factor of approximately 14. For a lithium-ion battery having a voltage approximately in the range 3.5 V-3.9 V, the boost voltage may be in the range 45 V-55 V to obtain an energy enhancement factor of approximately 200.

The electrostatic energy (E) stored in a capacitor may be expressed as E=(½) CV², where C is the physical capacitance of the capacitor and V is the charging voltage. For example, the supply voltage may be approximately 4 V and the boost voltage may be approximately 16 V, or 4 times greater than the supply voltage. The boost factor may be the ratio of the boost voltage to the supply voltage (e.g., a time averaged supply voltage). For example, if the boost voltage is 16 V and the supply voltage is 4 V, the boost factor may be 4. In some examples, the energy stored in the capacitor at the boost voltage of 16 V may be 16 times greater than that stored in the same capacitor charged at the supply voltage of 4 V. The enhancement factor may be determined as the energy stored by the capacitor at the boost voltage divided by the energy stored by the capacitor at the supply voltage. In some examples, the enhancement factor may be termed an energy enhancement factor and may be at least approximately equal to the square of the boost factor.

A boost circuit (e.g., a digital boost circuit) may include a voltage input receiving the supply voltage, a ground connection, an inductor, a diode, a capacitor, and a switch (e.g., a switching transistor). In some examples, the supply voltage is received at one terminal of the inductor, and the other terminal of the inductor is connected to a terminal of the switching transistor and a first terminal of a diode. The second terminal of the diode may be connected to a first terminal of a capacitor (which in this context may be termed a storage capacitor). A second terminal of the switching transistor and the second terminal of the storage capacitor may be connected to ground. The transistor may have a third terminal (e.g., a base or gate) that receives a switching signal (e.g., a square-wave signal) that may be received from or under the control of the controller. The voltage (and also, e.g., the enhancement factor) may be controlled by the presence of the switching signal and may also be adjusted by varying the duty ratio of the switching signal.

A voltage reduction circuit (sometimes termed a buck circuit) may include a voltage input (e.g., connected to the storage capacitor), a switch (e.g., a switching transistor) connected between the voltage input and the first terminal of both an inductor and a diode. The second terminal of the inductor may be connected to the supply voltage. The second terminal of the diode may be connected to ground. An additional capacitor may be located between the second terminal of the inductor and ground. Applying a switching signal to the gate or base of the switching transistor may result in a voltage lower than the storage capacitor voltage and which may be approximately equal to the average supply voltage.

In some examples, any suitable voltage multiplier and/or voltage divider circuit may be used, such as arrangements of diodes and capacitors, switched capacitor circuits, charge pumps, integrated circuit based circuits, and the like. In some examples, any suitable dc-dc converter may be used. Example switching transistors may include a field-effect transistor (FET) such as a metal-oxide-semiconductor FET (MOSFET).

In some examples, a capacitor may be (or include) an aluminum capacitor, a tantalum capacitor, or other metal-based capacitor. An example metal-based capacitor may include a metal anode (e.g., a metal film), a metal oxide layer (e.g., formed by anodization of the metal anode), an electrolyte layer (e.g., a solid or liquid electrolyte), and a cathode layer (e.g., a second metal layer). The metal anode may be roughened to increase the surface area of the anode. Example metals, such as metal films, may include aluminum, tantalum, or other metals such as other transition metals. An example aluminum capacitor may include an aluminum anode, an aluminum oxide layer (e.g., formed by anodization of the aluminum anode), an electrolyte layer (e.g., a solid or liquid electrolyte), and a cathode layer (e.g., a second aluminum layer).

The form factor of the circuit may be significantly less than that of a single component capacitor having the effective capacitance. For example, experimentation showed that effective results were obtained using aluminum or tantalum based electrolytic capacitors having a maximum on-board height of less than 8 mm and, in some examples, less than 4 mm. An example circuit was constructed having a quiescent current of less than 3 mA, corresponding to a quiescent power consumption of less than 10 mW, and an equivalent series resistance of less than 100 milliohms. Any suitable microcontroller may be used, and in some examples a control circuit including one or more microprocessors may provide the function of the microcontroller.

FIG. 19 shows a further block diagram of a circuit according to some examples. The circuit 1900 includes a power supply 1910, a resistance 1912, a load 1914 and a supercapacitor circuit 1920. Ground connections are not shown for illustrative clarity. A power supply line having a supply voltage denoted V connects the power supply 1910 and the load 1914. The power supply 1910 may include a battery, such as a lithium ion battery (e.g., providing a supply voltage between 3.4 and 4.2 V), and the resistance 1912 may represent an internal power supply resistance and/or at least part of the resistance of the electrical connection to the load. The resistance 1912 may include inherent properties of other components (e.g., the power supply 1910 and its electrical connections) and may not be a separate component. In some examples, the resistance 1912 may be in the range of approximately 0.01 ohms to approximately 1 ohm, such as approximately 0.1 ohms. The supercapacitor circuit 1920 may include connections (e.g., connection 1930) to a controller 1932 and a capacitor 1934. The controller and capacitor may be supported by the same circuit board. In evaluation tests, the load was a pulsed load (e.g., having a pulse width of 2 ms) with an average power consumption of 5 W. In some examples, the load may include an AR/VR device, which may include a display, display driver, backlight, processor, memory, audio components, haptic components and/or any other suitable components. AR/VR devices are discussed in more detail below.

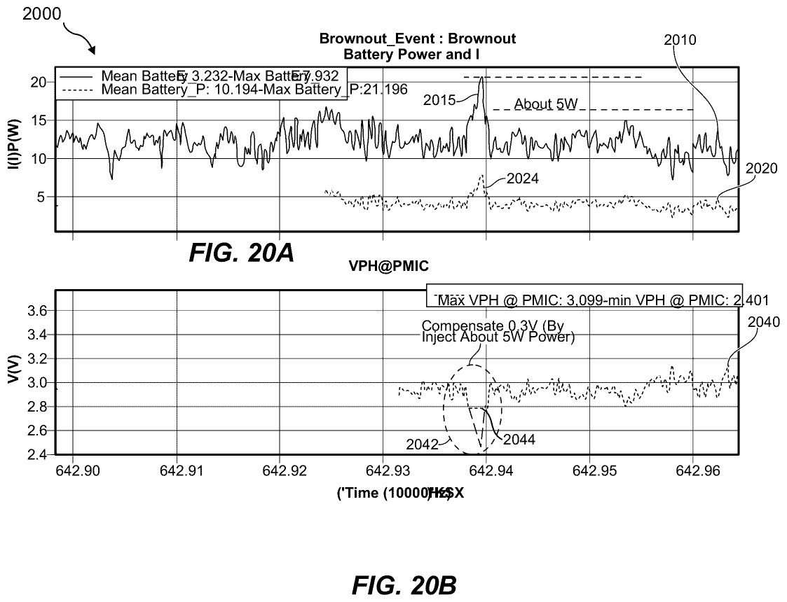

FIGS. 20A and 20B illustrate the response of an example load (such as an AR/VR device) to a brownout event.

FIG. 20A shows a chart 2000 illustrating the battery input power 2010 (solid line) as a function of time (arbitrary units). In this example, the mean power demand is 10.2 W and the peak power demand is 21.2 W. The power demand peak 2015 corresponds to a power demand surge from the load. FIG. 20A also shows the battery current demand as dashed line 320, having an average current demand of 3.2 A and a peak current demand 2024 with a peak current of 7.9 A.

FIG. 20B illustrates the voltage 2040 available to the load as a function of time over a time period similar to that shown in FIG. 20A. The maximum voltage is 3.10 V and the minimum voltage is 2.40 V. The minimum voltage occurs during the power demand peak 2015 shown in FIG. 20A. The power demand peak 2015 (FIG. 20A) results in an appreciable voltage drop 2042 in the voltage available to the load. This voltage drop may result in a brown-out if the lower voltage compromises the performance of one or more device components. For example, the display may dim and augmented reality image renderings may freeze. These effects are generally undesirable to a user. The brown-out may be avoided by a temporary injection of power. For example, as shown by the upper dashed line 2044 within the voltage drop 2042, an injection of approximately 5 W during the power demand peak may reduce the voltage drop to about 0.3 V, so that the lowest voltage becomes approximately 2.8 V.

The injected power may be obtained from a capacitor, for example, a capacitor located between the power supply line and ground (or a negative power supply line). In an AR/VR device, the injected power demand may appear to require a capacitor having a physical size that is difficult to include in an AR/VR headset having a desired form factor. However, by introducing a supercapacitor circuit, a capacitor having an appreciably reduced physical capacitance and physical size may be used.

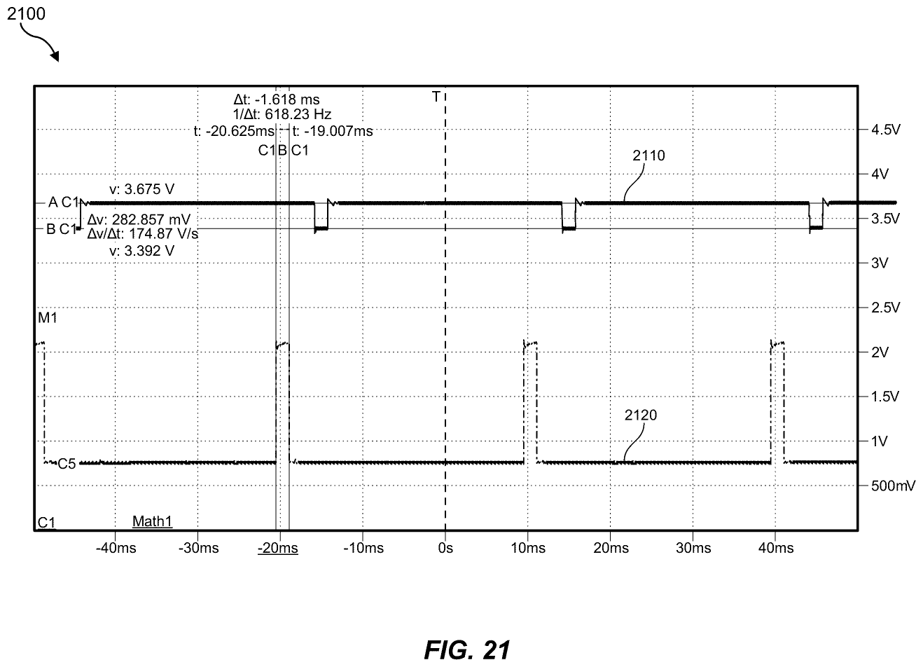

FIG. 21 illustrates an example circuit response 2100 to a brownout event without an additional capacitor to provide a power injection. In this example, the peak current draw results in a supply voltage drop of 283 mV shown in the upper curve 2110. At approximately the same time, the load draws a pulsed peak current of 1.34 A shown in the lower curve 2120.

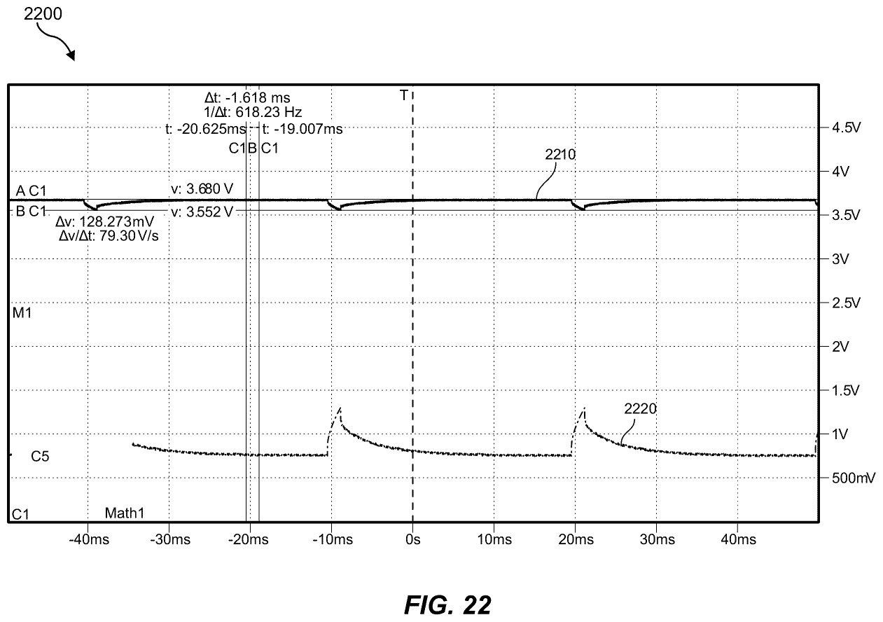

FIG. 22 shows an example circuit response 2200 to a brownout event with an additional capacitor of 20 mF to provide a power injection. In this example, the peak current draw results in a voltage ripple of 128 mV shown in the upper curve 2210. The load draws a peak current of 0.57 A shown in the lower curve 2220, which is less than that discussed above in relation to FIG. 21. Both the peak current and voltage variations are less than those discussed above in relation to FIG. 21.

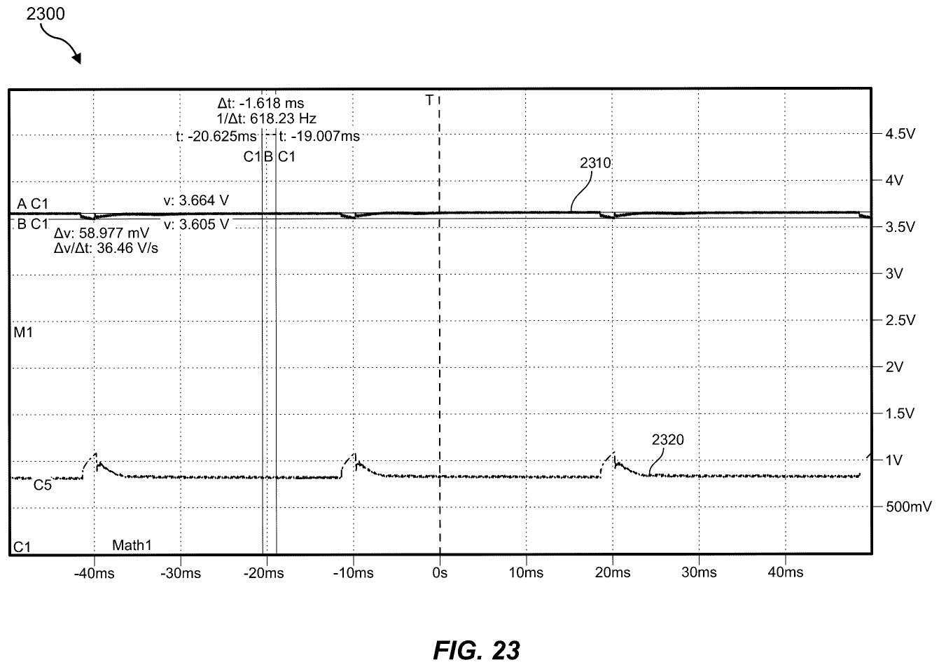

FIG. 23 shows an example circuit response 2300 to a brownout event with an additional supercapacitor circuit to provide a power injection. In this example, the peak current draw results in a voltage ripple of 59 mV as shown in the upper curve 2310. The load draws a peak current of 0.35 shown in the lower curve 2320, which is less than that those discussed above in relation to FIGS. 21 and 22. Both the peak current and voltage variations are less than those discussed above in relation to FIGS. 21 and 22. For example, the voltage ripple may be approximately or less than one half of the voltage ripple using the same capacitor with no supercapacitor circuit. Using a supercapacitor circuit, the peak current draw (e.g., from a battery or other power supply) may be reduced from approximately 1.35 A (e.g., as shown in FIG. 21) to 0.35 A as shown in FIG. 23. In some examples, a supercapacitor circuit may reduce the peak current draw to less than 30% of that obtained without a supercapacitor circuit (e.g., using the same capacitor).

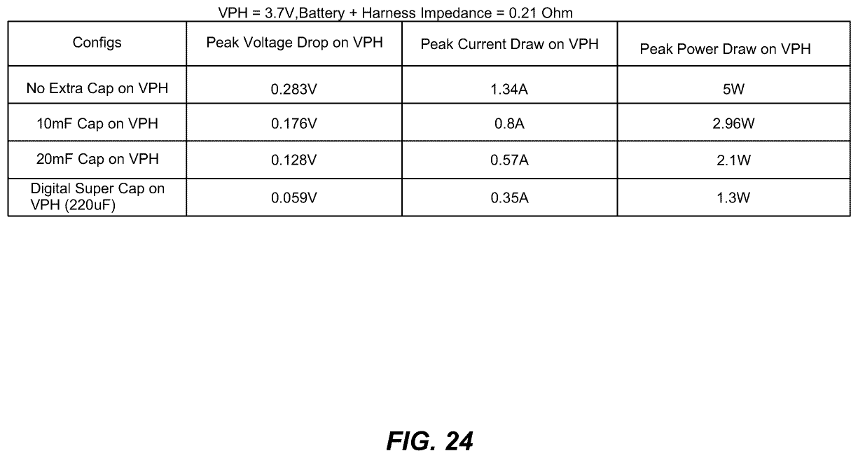

FIG. 24 shows a table illustrating the excellent performance of a digital supercapacitor circuit. The “no extra capacitor” data corresponds to FIG. 21, the “20 mF capacitor” data corresponds to FIG. 22, and the supercapacitor data corresponds to FIG. 23. The supercapacitor circuit shows improved performance compared with the use of capacitors without the supercapacitor circuit. The supercapacitor circuit reduces the peak power draw from the voltage supply (e.g., a lithium-ion battery) using energy stored in the capacitor of the supercapacitor circuit. For example, if the peak power drawn by the load is 5 W this may lead to visually discernable displayed image artifacts, such as the appearance of brown-out. In this context, brown-out may refer to the transient dimming of a displayed image, image freezing on the display, or other visually-discernable artifact. If some or all of the peak power drawn is supplied by a supercapacitor circuit then the peak power draw on the battery may be reduced and the visually-discernable artifacts reduced or eliminated. As shown in FIG. 24, a supercapacitor circuit including a 220 microfarad capacitor may reduce the peak power demand on a dedicated power source from 5 W to 1.3 W. This provides visually discernable improvements in a displayed image through periods of transient power demand. A supercapacitor circuit including a 220 microfarad capacitor may reduce the magnitude of the peak voltage drop experienced by the load (e.g., an AR/VR device) from 0.28 V to 0.06 V, and the peak current draw from the dedicated power supply may be reduced from 1.34 A to 0.35 A.

In some examples, a method may include charging a capacitor using a boost voltage that may by higher than the supply voltage. For example, the supply voltage may be between approximately 2 V and approximately 5 V. The boost voltage may be between approximately 10 V and approximately 60 V. The boost voltage may be provided by a boost circuit that receives the supply voltage and provides the boost voltage. Operation of the boost circuit (e.g., activation of the circuit and/or adjustment of the output voltage may be controlled by a controller, such as a microcontroller. For example, the microcontroller may be used to provide a boost switching signal, such as a pulsed signal, that may allow the boost circuit to operate. For example, a pulsed signal may be provided to the base or gate of one or more transistors. The duty ratio of the pulsed signal may be used to adjust the boost voltage. The controller may be used to detect a voltage drop in the supply voltage. In response to the voltage drop, the controller may deactivate the boost circuit, and allow the capacitor to at least partially discharge through a voltage reduction circuit. The controller may activate the voltage reduction circuit using a voltage reduction switching signal, such as a second pulsed signal. The duty ratio of the pulsed signal may be used to adjust the capacitor discharge signal at the boost voltage to a capacitive discharge signal at least approximately equal to the supply voltage, which may be used to reduce the voltage drop. In some examples, a plurality of capacitors may be charged to a respective boost voltage, and one or more of the plurality of capacitors may be discharged to reduce the magnitude of a voltage drop when detected.

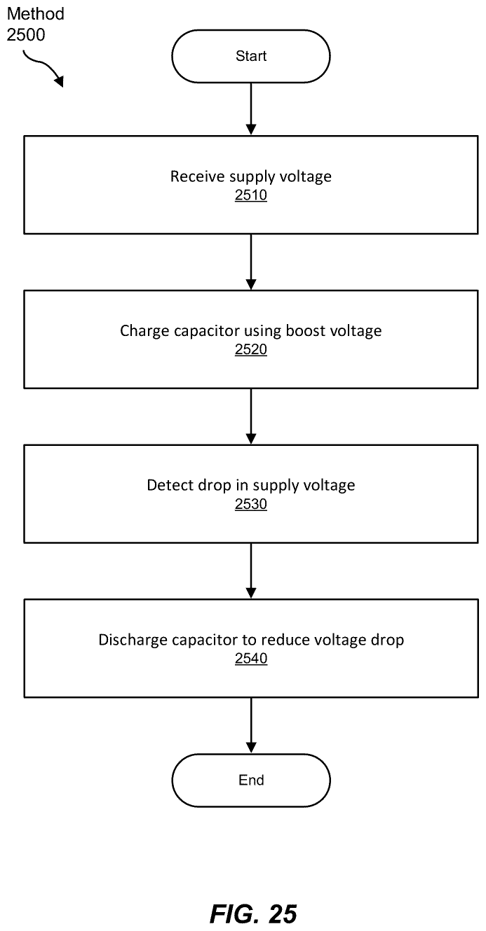

FIG. 25 illustrates a method 2500. The method 2500 may include receiving a supply voltage (2510), charging a capacitor using a boost voltage (2520), detecting a drop in the supply voltage (2530), and discharging the capacitor to reduce the voltage drop (2540). The boost voltage may be greater than the supply voltage. In some examples, the boost voltage may be at least double, at least five times, at least ten times, or at least 20 times the supply voltage. The capacitor may be charged through a boost circuit that is configured to increase the supply voltage to the boost voltage. The capacitor may be discharged through a voltage reduction circuit (sometimes termed a buck circuit). In some examples, the method may be performed by an AR/VR device. In some examples, the method may be performed by the microcontroller of the AR/VR device.

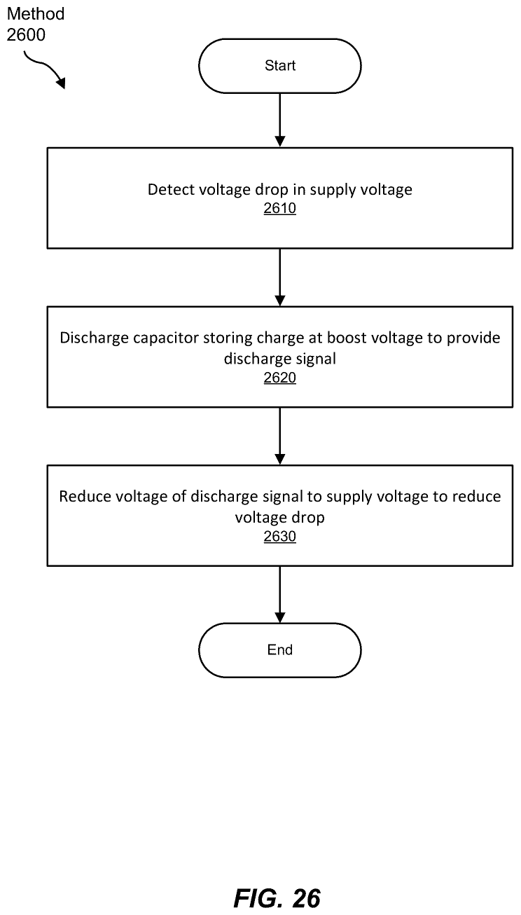

FIG. 26 illustrates a method 2600. The method 2600 may include: detecting a voltage drop in a supply voltage (2610); at least partially discharging a capacitor that stores charge at a boost voltage (2620) to provide a discharge signal; and reducing the voltage of the discharge signal (2630) to a value approximately equal to the supply voltage to augment the supply voltage and/or supply current.

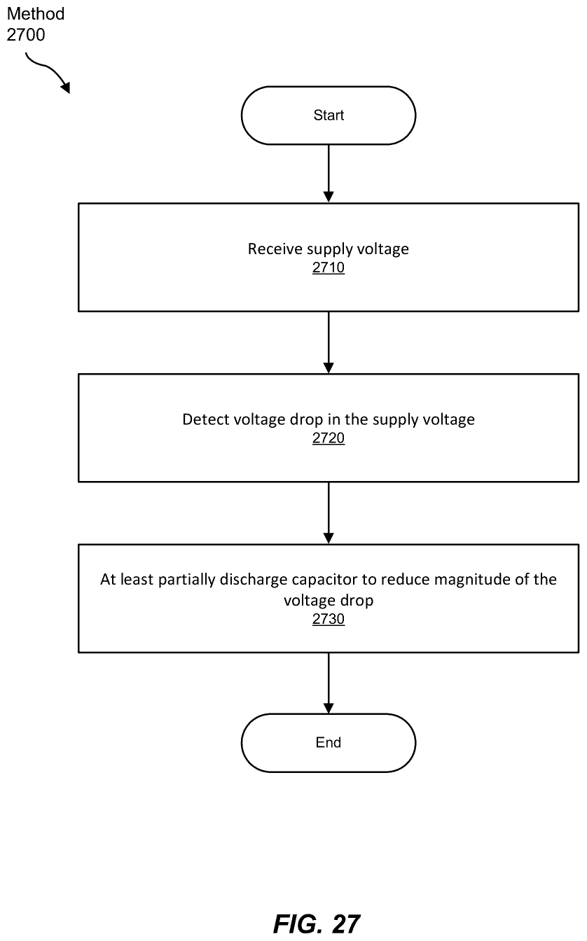

FIG. 27 illustrates a method 2700. The method 2700 may include receiving a supply voltage (2710), detecting a voltage drop in the supply voltage (2720), and at least partially discharging a capacitor to reduce the magnitude of the voltage drop (2730), where the capacitor holds charge at higher voltage than the supply voltage.

A microcontroller may be configured to monitor the supply voltage and to charge the capacitor while the supply voltage is greater than a particular percentage of the average and/or design supply voltage. The particular percentage may be at least 80%, such as at least 90%, and may be approximately 100% of the average and/or design voltage. The microcontroller may be configured to at least partially discharge the capacitor when the supply voltage has a voltage drop (e.g., relative to an average or design voltage) of greater magnitude than a particular threshold voltage drop. The particular threshold voltage drop may be at least 0.1 V, such as at least 0.2 V, such as at least 0.3 V. Capacitor discharge may be slowed or stopped after the supply voltage returns to the particular percentage of the average and/or design supply voltage, and charging the capacitor may then resume (e.g., after a predetermined delay time, or, e.g., when the supply voltage becomes greater than the average and/or design supply voltage.

Example methods may include computer-implemented methods for operating or fabricating an apparatus, such as an apparatus as described herein. The steps of an example method, such as adhering components together, may be performed by any suitable computer-executable code and/or computing system. In some examples, one or more of the steps of an example method may represent an algorithm whose structure includes and/or may be represented by multiple sub-steps. In some examples, a method for assembling an optical device such as an AR/VR device may include computer control of an apparatus, for example, to fabricate a circuit board including a supercapacitor circuit.

In some examples, an apparatus may include at least one physical processor and physical memory including computer-executable instructions that, when executed by the physical processor, cause the physical processor to control an apparatus, for example, using a method such as described herein. In some examples, an apparatus may include a microcontroller which may be pre-programmed with firmware. The firmware may be updated based on device performance, for example, based on device performance for a particular user. For example, the duty ratio of a switching circuit may be adjusted based on the number and magnitude of voltage drops during use. In some examples, the microcontroller, capacitor, and other components may be supported on a circuit board. The circuit board may be located proximate a lithium ion battery and/or may be located proximate the voltage input of the AR/VR circuit. The area of the circuit board may be less than 200 square millimeters.

In some examples, a non-transitory computer-readable medium may include one or more computer-executable instructions that, when executed by at least one processor of an apparatus, cause the apparatus to at least partially assemble an optical device, for example, using a method such as described herein.

Examples include a power supply that includes a controller (e.g., a digital control unit, DCU) that is configured to control the charge and discharge of a capacitor. The controller may direct charge to the capacitor from the supply voltage. To increase the charge on the capacitor, the supply voltage may be boosted to a higher voltage. The controller may direct charge from the capacitor from the supply voltage line to reduce voltage drops due to high current draw by the device from the power supply. The controller may control the charge or discharge of the capacitor based on the current demand of the device from the power supply and/or a voltage drop in the supply voltage (e.g., due to increased current demand).

In some examples, a supercapacitor circuit may include a digital boost, a digital buck, and a controller. The supercapacitor circuit may help stabilize the supply voltage to other components of the device, such as other components of an AR/VR device. The controller allows a voltage stabilization of an equivalent capacitance that may be 100 times or 200 times large than the physical capacitance of the capacitor used in the supercapacitor circuit. The supercapacitor circuit may be used in a mobile device (e.g., a mobile phone or other portable electronic device) or a head-mounted device (e.g., an AR/VR device), for example, to reduce peak power demand issues. A power supply may include at least one battery, such as at least one lithium-ion battery. In this context, a mixed reality (MR) device may be considered to be a type of AR device.

In some examples, an AR/VR device may include a voltage boost circuit to increase the voltage that can be applied to a charge storage capacitor. The increased voltage increases the charge that can be stored in the capacitor and allows a physically smaller capacitor to be used in the device circuit to store a particular charge. The stored charge can be used to avoid brown-outs or other electrical anomalies during periods of high power consumption Example apparatus may include a voltage input configured to receive a supply voltage and a supercapacitor circuit including a capacitor, a voltage boost circuit configured to receive the supply voltage and to provide a boost voltage to charge the capacitor, and a voltage reduction circuit configured to receive stored charge from the capacitor and to provide a discharge signal, and a controller. The controller may be configured to detect a voltage drop in the supply voltage and operate the voltage reduction circuit to reduce the voltage drop using the discharge signal. The apparatus may include a head-mounted device, such as an augmented reality and/or virtual reality device. The apparatus may include a display configured to provide augmented reality elements to a user when the user wears the head-mounted device. Examples include other devices, methods, systems, and computer-readable media.

Embodiments of the present disclosure may include or be implemented in conjunction with various types of artificial-reality systems. Artificial reality is a form of reality that has been adjusted in some manner before presentation to a user, which may include, for example, a virtual reality, an augmented reality, a mixed reality, a hybrid reality, or some combination and/or derivative thereof. Artificial-reality content may include completely computer-generated content or computer-generated content combined with captured (e.g., real-world) content. The artificial-reality content may include video, audio, haptic feedback, or some combination thereof, any of which may be presented in a single channel or in multiple channels (such as stereo video that produces a three-dimensional (3D) effect to the viewer). Additionally, in some embodiments, artificial reality may also be associated with applications, products, accessories, services, or some combination thereof, that are used to, for example, create content in an artificial reality and/or are otherwise used in (e.g., to perform activities in) an artificial reality.

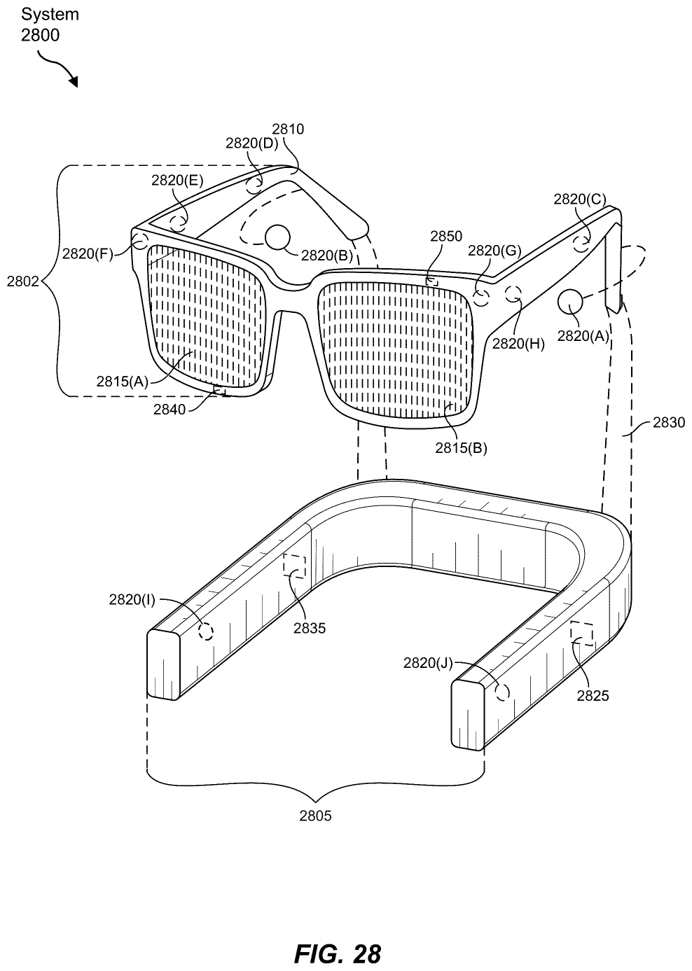

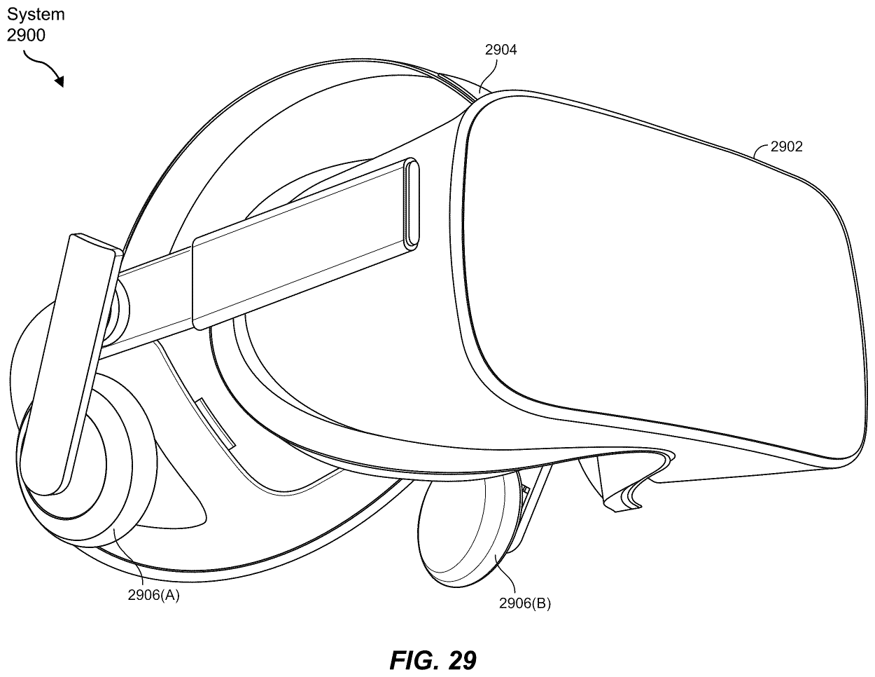

Artificial-reality systems may be implemented in a variety of different form factors and configurations. Some artificial-reality systems may be designed to work without near-eye displays (NEDs). Other artificial-reality systems may include an NED that also provides visibility into the real world (such as, e.g., augmented-reality system 2800 in FIG. 28) or that visually immerses a user in an artificial reality (such as, e.g., virtual-reality system 2900 in FIG. 29). While some artificial-reality devices may be self-contained systems, other artificial-reality devices may communicate and/or coordinate with external devices to provide an artificial-reality experience to a user. Examples of such external devices include handheld controllers, mobile devices, desktop computers, devices worn by a user, devices worn by one or more other users, and/or any other suitable external system.

Turning to FIG. 28, augmented-reality system 2800 may include an eyewear device 2802 with a frame 2810 configured to hold a left display device 2815(A) and a right display device 2815(B) in front of a user's eyes. Display devices 2815(A) and 2815(B) may act together or independently to present an image or series of images to a user. While augmented-reality system 2800 includes two displays, embodiments of this disclosure may be implemented in augmented-reality systems with a single NED or more than two NEDs.

In some embodiments, augmented-reality system 2800 may include one or more sensors, such as sensor 2840. Sensor 2840 may generate measurement signals in response to motion of augmented-reality system 2800 and may be located on substantially any portion of frame 2810. Sensor 2840 may represent one or more of a variety of different sensing mechanisms, such as a position sensor, an inertial measurement unit (IMU), a depth camera assembly, a structured light emitter and/or detector, or any combination thereof. In some embodiments, augmented-reality system 2800 may or may not include sensor 2840 or may include more than one sensor. In embodiments in which sensor 2840 includes an IMU, the IMU may generate calibration data based on measurement signals from sensor 2840. Examples of sensor 2840 may include, without limitation, accelerometers, gyroscopes, magnetometers, other suitable types of sensors that detect motion, sensors used for error correction of the IMU, or some combination thereof.

In some examples, augmented-reality system 2800 may also include a microphone array with a plurality of acoustic transducers 2820(A)-2820(J), referred to collectively as acoustic transducers 2820. Acoustic transducers 2820 may represent transducers that detect air pressure variations induced by sound waves. Each acoustic transducer 2820 may be configured to detect sound and convert the detected sound into an electronic format (e.g., an analog or digital format). The microphone array in FIG. 28 may include, for example, ten acoustic transducers: 2820(A) and 2820(B), which may be designed to be placed inside a corresponding ear of the user, acoustic transducers 2820(C), 2820(D), 2820(E), 2820(F), 2820(G), and 2820(H), which may be positioned at various locations on frame 2810, and/or acoustic transducers 2820(I) and 2820(J), which may be positioned on a corresponding neckband 2805.

In some embodiments, one or more of acoustic transducers 2820(A)-(J) may be used as output transducers (e.g., speakers). For example, acoustic transducers 2820(A) and/or 2820(B) may be earbuds or any other suitable type of headphone or speaker.

The configuration of acoustic transducers 2820 of the microphone array may vary. While augmented-reality system 2800 is shown in FIG. 28 as having ten acoustic transducers 2820, the number of acoustic transducers 2820 may be greater or less than ten. In some embodiments, using higher numbers of acoustic transducers 2820 may increase the amount of audio information collected and/or the sensitivity and accuracy of the audio information. In contrast, using a lower number of acoustic transducers 2820 may decrease the computing power required by an associated controller 2850 to process the collected audio information. In addition, the position of each acoustic transducer 2820 of the microphone array may vary. For example, the position of an acoustic transducer 2820 may include a defined position on the user, a defined coordinate on frame 2810, an orientation associated with each acoustic transducer 2820, or some combination thereof.

Acoustic transducers 2820(A) and 2820(B) may be positioned on different parts of the user's ear, such as behind the pinna, behind the tragus, and/or within the auricle or fossa. Or, there may be additional acoustic transducers 2820 on or surrounding the ear in addition to acoustic transducers 2820 inside the ear canal. Having an acoustic transducer 2820 positioned next to an ear canal of a user may enable the microphone array to collect information on how sounds arrive at the ear canal. By positioning at least two of acoustic transducers 2820 on either side of a user's head (e.g., as binaural microphones), augmented-reality device 2800 may simulate binaural hearing and capture a 3D stereo sound field around about a user's head. In some embodiments, acoustic transducers 2820(A) and 2820(B) may be connected to augmented-reality system 2800 via a wired connection 2830, and in other embodiments acoustic transducers 2820(A) and 2820(B) may be connected to augmented-reality system 2800 via a wireless connection (e.g., a BLUETOOTH connection). In still other embodiments, acoustic transducers 2820(A) and 2820(B) may not be used at all in conjunction with augmented-reality system 2800.

Acoustic transducers 2820 on frame 2810 may be positioned in a variety of different ways, including along the length of the temples, across the bridge, above or below display devices 2815(A) and 2815(B), or some combination thereof. Acoustic transducers 2820 may also be oriented such that the microphone array is able to detect sounds in a wide range of directions surrounding the user wearing the augmented-reality system 2800. In some embodiments, an optimization process may be performed during manufacturing of augmented-reality system 2800 to determine relative positioning of each acoustic transducer 2820 in the microphone array.

In some examples, augmented-reality system 2800 may include or be connected to an external device (e.g., a paired device), such as neckband 2805. Neckband 2805 generally represents any type or form of paired device. Thus, the following discussion of neckband 2805 may also apply to various other paired devices, such as charging cases, smart watches, smart phones, wrist bands, other wearable devices, hand-held controllers, tablet computers, laptop computers, other external compute devices, etc.

As shown, neckband 2805 may be coupled to eyewear device 2802 via one or more connectors. The connectors may be wired or wireless and may include electrical and/or non-electrical (e.g., structural) components. In some cases, eyewear device 2802 and neckband 2805 may operate independently without any wired or wireless connection between them. While FIG. 28 illustrates the components of eyewear device 2802 and neckband 2805 in example locations on eyewear device 2802 and neckband 2805, the components may be located elsewhere and/or distributed differently on eyewear device 2802 and/or neckband 2805. In some embodiments, the components of eyewear device 2802 and neckband 2805 may be located on one or more additional peripheral devices paired with eyewear device 2802, neckband 2805, or some combination thereof.

Pairing external devices, such as neckband 2805, with augmented-reality eyewear devices may enable the eyewear devices to achieve the form factor of a pair of glasses while still providing sufficient battery and computation power for expanded capabilities. Some or all of the battery power, computational resources, and/or additional features of augmented-reality system 2800 may be provided by a paired device or shared between a paired device and an eyewear device, thus reducing the weight, heat profile, and form factor of the eyewear device overall while still retaining desired functionality. For example, neckband 2805 may allow components that would otherwise be included on an eyewear device to be included in neckband 2805 since users may tolerate a heavier weight load on their shoulders than they would tolerate on their heads. Neckband 2805 may also have a larger surface area over which to diffuse and disperse heat to the ambient environment. Thus, neckband 2805 may allow for greater battery and computation capacity than might otherwise have been possible on a stand-alone eyewear device. Since weight carried in neckband 2805 may be less invasive to a user than weight carried in eyewear device 2802, a user may tolerate wearing a lighter eyewear device and carrying or wearing the paired device for greater lengths of time than a user would tolerate wearing a heavy standalone eyewear device, thereby enabling users to more fully incorporate artificial-reality environments into their day-to-day activities.

Neckband 2805 may be communicatively coupled with eyewear device 2802 and/or to other devices. These other devices may provide certain functions (e.g., tracking, localizing, depth mapping, processing, storage, etc.) to augmented-reality system 2800. In the embodiment of FIG. 28, neckband 2805 may include two acoustic transducers (e.g., 2820(I) and 2820(J)) that are part of the microphone array (or potentially form their own microphone subarray). Neckband 2805 may also include a controller 2825 and a power source 2835.

Acoustic transducers 2820(I) and 2820(J) of neckband 2805 may be configured to detect sound and convert the detected sound into an electronic format (analog or digital). In the embodiment of FIG. 28, acoustic transducers 2820(I) and 2820(J) may be positioned on neckband 2805, thereby increasing the distance between the neckband acoustic transducers 2820(I) and 2820(J) and other acoustic transducers 2820 positioned on eyewear device 2802. In some cases, increasing the distance between acoustic transducers 2820 of the microphone array may improve the accuracy of beamforming performed via the microphone array. For example, if a sound is detected by acoustic transducers 2820(C) and 2820(D) and the distance between acoustic transducers 2820(C) and 2820(D) is greater than, e.g., the distance between acoustic transducers 2820(D) and 2820(E), the determined source location of the detected sound may be more accurate than if the sound had been detected by acoustic transducers 2820(D) and 2820(E).

Controller 2825 of neckband 2805 may process information generated by the sensors on neckband 2805 and/or augmented-reality system 2800. For example, controller 2825 may process information from the microphone array that describes sounds detected by the microphone array. For each detected sound, controller 2825 may perform a direction-of-arrival (DOA) estimation to estimate a direction from which the detected sound arrived at the microphone array. As the microphone array detects sounds, controller 2825 may populate an audio data set with the information. In embodiments in which augmented reality system 2800 includes an inertial measurement unit, controller 2825 may compute all inertial and spatial calculations from the IMU located on eyewear device 2802. A connector may convey information between augmented-reality system 2800 and neckband 2805 and between augmented-reality system 2800 and controller 2825. The information may be in the form of optical data, electrical data, wireless data, or any other transmittable data form. Moving the processing of information generated by augmented-reality system 2800 to neckband 2805 may reduce weight and heat in eyewear device 2802, making it more comfortable to the user.

Power source 2835 in neckband 2805 may provide power to eyewear device 2802 and/or to neckband 2805. Power source 2835 may include, without limitation, lithium ion batteries, lithium-polymer batteries, primary lithium batteries, alkaline batteries, or any other form of power storage. In some cases, power source 2835 may be a wired power source. Including power source 2835 on neckband 2805 instead of on eyewear device 2802 may help better distribute the weight and heat generated by power source 2835.

As noted, some artificial-reality systems may, instead of blending an artificial reality with actual reality, substantially replace one or more of a user's sensory perceptions of the real world with a virtual experience. One example of this type of system is a head-worn display system, such as virtual-reality system 2900 in FIG. 29, that mostly or completely covers a user's field of view. Virtual-reality system 2900 may include a front rigid body 2902 and a band 2904 shaped to fit around a user's head. Virtual-reality system 2900 may also include output audio transducers 2906(A) and 2906(B). Furthermore, while not shown in FIG. 29, front rigid body 2902 may include one or more electronic elements, including one or more electronic displays, one or more inertial measurement units (IMUs), one or more tracking emitters or detectors, and/or any other suitable device or system for creating an artificial-reality experience.

Artificial-reality systems may include a variety of types of visual feedback mechanisms. For example, display devices in augmented-reality system 2800 and/or virtual-reality system 2900 may include one or more liquid crystal displays (LCDs), light emitting diode (LED) displays, microLED displays, organic LED (OLED) displays, digital light project (DLP) micro-displays, liquid crystal on silicon (LCoS) micro-displays, and/or any other suitable type of display screen. These artificial-reality systems may include a single display screen for both eyes or may provide a display screen for each eye, which may allow for additional flexibility for varifocal adjustments or for correcting a user's refractive error. Some of these artificial-reality systems may also include optical subsystems having one or more lenses (e.g., concave or convex lenses, Fresnel lenses, adjustable liquid lenses, etc.) through which a user may view a display screen. These optical subsystems may serve a variety of purposes, including to collimate (e.g., make an object appear at a greater distance than its physical distance), to magnify (e.g., make an object appear larger than its actual size), and/or to relay (to, e.g., the viewer's eyes) light. These optical subsystems may be used in a non-pupil-forming architecture (such as a single lens configuration that directly collimates light but results in so-called pincushion distortion) and/or a pupil-forming architecture (such as a multi-lens configuration that produces so-called barrel distortion to nullify pincushion distortion).

In addition to or instead of using display screens, some of the artificial-reality systems described herein may include one or more projection systems. For example, display devices in augmented-reality system 2800 and/or virtual-reality system 2900 may include microLED projectors that project light (using, e.g., a waveguide) into display devices, such as clear combiner lenses that allow ambient light to pass through. The display devices may refract the projected light toward a user's pupil and may enable a user to simultaneously view both artificial-reality content and the real world. The display devices may accomplish this using any of a variety of different optical components, including waveguide components (e.g., holographic, planar, diffractive, polarized, and/or reflective waveguide elements), light-manipulation surfaces and elements (such as diffractive, reflective, and refractive elements and gratings), coupling elements, etc. Artificial-reality systems may also be configured with any other suitable type or form of image projection system, such as retinal projectors used in virtual retina displays.

The artificial-reality systems described herein may also include various types of computer vision components and subsystems. For example, augmented-reality system 2800 and/or virtual-reality system 2900 may include one or more optical sensors, such as two-dimensional (2D) or 3D cameras, structured light transmitters and detectors, time-of-flight depth sensors, single-beam or sweeping laser rangefinders, 3D LiDAR sensors, and/or any other suitable type or form of optical sensor. An artificial-reality system may process data from one or more of these sensors to identify a location of a user, to map the real world, to provide a user with context about real-world surroundings, and/or to perform a variety of other functions.

The artificial-reality systems described herein may also include one or more input and/or output audio transducers. Output audio transducers may include voice coil speakers, ribbon speakers, electrostatic speakers, piezoelectric speakers, bone conduction transducers, cartilage conduction transducers, tragus-vibration transducers, and/or any other suitable type or form of audio transducer. Similarly, input audio transducers may include condenser microphones, dynamic microphones, ribbon microphones, and/or any other type or form of input transducer. In some embodiments, a single transducer may be used for both audio input and audio output.

In some embodiments, the artificial-reality systems described herein may also include tactile (i.e., haptic) feedback systems, which may be incorporated into headwear, gloves, body suits, handheld controllers, environmental devices (e.g., chairs, floormats, etc.), and/or any other type of device or system. Haptic feedback systems may provide various types of cutaneous feedback, including vibration, force, traction, texture, and/or temperature. Haptic feedback systems may also provide various types of kinesthetic feedback, such as motion and compliance. Haptic feedback may be implemented using motors, piezoelectric actuators, fluidic systems, and/or a variety of other types of feedback mechanisms. Haptic feedback systems may be implemented independent of other artificial-reality devices, within other artificial-reality devices, and/or in conjunction with other artificial-reality devices.

By providing haptic sensations, audible content, and/or visual content, artificial-reality systems may create an entire virtual experience or enhance a user's real-world experience in a variety of contexts and environments. For instance, artificial-reality systems may assist or extend a user's perception, memory, or cognition within a particular environment. Some systems may enhance a user's interactions with other people in the real world or may enable more immersive interactions with other people in a virtual world. Artificial-reality systems may also be used for educational purposes (e.g., for teaching or training in schools, hospitals, government organizations, military organizations, business enterprises, etc.), entertainment purposes (e.g., for playing video games, listening to music, watching video content, etc.), and/or for accessibility purposes (e.g., as hearing aids, visual aids, etc.). The embodiments disclosed herein may enable or enhance a user's artificial-reality experience in one or more of these contexts and environments and/or in other contexts and environments.

### Example Embodiments

Example 1: An example apparatus may include a voltage input configured to receive a supply voltage, and a supercapacitor circuit including a capacitor, a voltage boost circuit configured to receive the supply voltage and to provide a boost voltage to charge the capacitor, a voltage reduction circuit configured to receive a stored charge from the capacitor and to provide a discharge signal to the voltage input, and a controller configured to control operation of the voltage boost circuit and the voltage reduction circuit, detect a voltage drop in the supply voltage, and operate the voltage reduction circuit to provide the discharge signal to the voltage input to reduce a magnitude of the voltage drop, where the apparatus is a head-mounted device, the apparatus includes a display, and the display is configured to provide augmented reality elements to a user when the user wears the head-mounted device.

Example 2. The apparatus of example 1, further including a lithium-ion battery configured to provide the supply voltage.

Example 3. The apparatus of examples 1 or 2, where the boost voltage is greater than the supply voltage by a boost factor, and the boost factor is between 2 and 20.

Example 4. The apparatus of examples 1-3, where the supply voltage is between 2 V and 5 V.

Example 5. The apparatus of examples 1-4, where the boost voltage is between 10 V and 60 V.

Example 6. The apparatus of examples 1-5, where an energy storage of the capacitor is increased by an enhancement factor by the supercapacitor circuit, and the enhancement factor is at least 10.

Example 7. The apparatus of examples 1-6, where the controller includes a microcontroller.

Example 8. The apparatus of examples 1-7, where the microcontroller, the capacitor, the voltage boost circuit, and the voltage reduction circuit are mounted on a circuit board, and the circuit board has an area less than 200 square millimeters.

Example 9. The apparatus of examples 1-8, where the capacitor is an electrolytic capacitor having an anode, and the anode includes a metal film.

Example 10. The apparatus of examples 1-9, where the metal film includes aluminum or tantalum.

Example 11. The apparatus of examples 1-10, where the capacitor has a physical capacitance of between 50 microfarads and 500 microfarads.

Example 12. The apparatus of examples 1-11, where the supercapacitor circuit is configured to reduce a peak current draw of the apparatus by at least 50%.

Example 13. The apparatus of examples 1-12, where the supercapacitor circuit is configured to reduce the voltage drop in the supply voltage by at least 0.2 V.

Example 14. The apparatus of examples 1-13, where the apparatus includes an augmented reality system.

Example 15. The apparatus of claims 1-14, where the augmented reality system includes augmented reality eyewear.

Example 16. The apparatus of examples 1-15, where the apparatus includes a virtual reality system.

Example 17. An example method may include receiving a supply voltage, charging a capacitor with a boost voltage that is higher than the supply voltage, detecting a voltage drop in the supply voltage, and discharging the capacitor through a voltage reduction circuit to reduce the voltage drop, where the method is performed by an augmented reality system or a virtual reality system.

Example 18. The method of example 17, where the method may be performed by an augmented reality system.

Example 19. The method of examples 17 or 18, where the boost voltage is at least double the supply voltage.

Example 20. The method of claims 17-19, where the supply voltage is provided by a lithium ion battery, and the boost voltage is between approximately 10 V and approximately 60 V.

What is claimed is:

1. A method for manufacturing an optical waveguide, the method comprising:
singulating a waveguide blank from a substrate to a substantially final shape;
after singulating the waveguide blank, apply an optical grating over the waveguide blank; and
after singulating the waveguide blank, apply at least one coating to the waveguide blank.
